(19) United States
(12) Patent Application Publication
(10) Pub. No.: US 2026/0072151 A1
(43) Pub. Date: Mar. 12, 2026

(54) TARGET DETECTION DEVICE AND TARGET DETECTION METHOD

(71) Applicant: Furuno Electric Co., Ltd., Nishinomiya-City (JP)

(72) Inventors: Kohei IWATA, Neyagawa (JP); Yasushi NISHIMORI, Takarazuka (JP)

(73) Assignee: Furuno Electric Co., Ltd., Nishinomiya-City (JP)

(21) Appl. No.: 19/393,636

(22) Filed: Nov. 19, 2025

Related U.S. Application Data
(63) Continuation of application No. PCT/JP2024/009708, filed on Mar. 13, 2024.

(30) Foreign Application Priority Data
Nov. 13, 2023 (JP) 2023-193179

(51) Int. Cl. G01S 7/524; G01S 7/527; G01S 15/42; G01S 15/96

(52) U.S. Cl. CPC G01S 7/524; G01S 7/5273; G01S 15/42; G01S 15/96

(57) ABSTRACT

A target detection device including a transmission signal generator, a transmission array, a switch, and a controller is disclosed. The transmission signal generator is configured to generate a transmission signal. The transmission array including a plurality of transmission elements is configured to convert the transmission signal into a transmission wave. The transmission array includes at least a start transmission element and an end transmission element. The switch is configured to supply the transmission signal to the plurality of transmission elements sequentially from the start transmission element to the end transmission element. The controller is configured to control a sweep time of the switch. The sweep time is a time from the supply of the transmission signal to the start transmission element to the supply of the transmission signal to the end transmission element.

### CROSS-REFERENCE TO RELATED APPLICATION(S)

This application is a continuation application of PCT International Application No. PCT/JP2024/009708, which was filed on Mar. 13, 2024, and which claims priority to Japanese Patent Application No. JP2023-193179 filed on Nov. 13, 2023, the entire disclosures of each of which are herein incorporated by reference for all purposes.

### TECHNICAL FIELD

The present disclosure relates to a target detection device and a target detection method for transmitting a transmission wave and detecting a target based on a reflected wave.

### BACKGROUND

Conventionally, a target detection device for transmitting a transmission wave and detecting a target based on a reflected wave is known. In such a target detection device, for example, a configuration in which a source of the transmission wave is moved in one direction to change a frequency of the transmission wave transmitted into water may be used.

For example, a plurality of transmission elements (e.g., ultrasonic oscillators) is arranged in one direction to form a transmission array. A transmission signal is sequentially supplied to the transmission elements in the arranged direction. As a result, the source of the transmission wave moves in the arranged direction. The Doppler effect caused by this movement changes the frequency of the transmission wave transmitted into the water within an angular range of the arranged direction.

A plurality of reception elements (e.g., ultrasonic oscillators) is arranged in a direction perpendicular to the arranged direction of the transmission elements to form a reception array. A reception signal is outputted from each reception element in response to the above transmission from the transmission elements. From these reception signals, a frequency component corresponding to each angle in the above angular range is extracted by a band limiting filter. Thereby, a reception signal included in an equal-frequency surface for each angle is acquired. Further, a reception signal in an angular direction along the corresponding equal-frequency surface is acquired by beamforming the reception signal in each equal-frequency surface.

In this way, a reception signal based on an echo is acquired at a predetermined angular resolution based on the band limiting filter and the beamforming in the angular range (i.e., detection range) of the arranged direction of the transmission elements and the arranged direction of the reception elements. From the reception signal, echo intensity data distributed three-dimensionally (i.e., volume data) in the detection range is acquired. By imaging the intensity data (i.e., volume data), an image showing a state of the target in the detection range may be obtained.

### SUMMARY

A first aspect of the present disclosure relates to a target detection device. The target detection device according to this aspect includes a transmission signal generator, a transmission array, a switch, and a controller. The transmission signal generator is configured to generate a transmission signal. The transmission array comprises a plurality of transmission elements and is configured to convert the transmission signal into a transmission wave. The transmission array comprises at least a start transmission element and an end transmission element. The switch is configured to supply the transmission signal to the plurality of transmission elements sequentially from the start transmission element to the end transmission element. The controller is configured to control a sweep time of the switch. The sweep time is a time from the supply of the transmission signal to the start transmission element to the supply of the transmission signal to the end transmission element.

According to the target detection device of the first aspect, for a device having a finite bandwidth, by changing the sweep time of the switch, a searchable angular range corresponding to an arranged direction (i.e., sweep direction) of the transmission elements may be changed. Therefore, the searchable angular range of the device having the finite bandwidth may be easily adjusted.

In the target detection device according to an embodiment, the sweep time may set an angular range in which the transmission wave is transmitted. An increase of the sweep time by the controller may widen the angular range.

By controlling the sweep time, the angular range in which the transmission wave is transmitted may be adjusted. Therefore, the searchable angular range for target detection may be changed by simple control.

A second aspect of the present disclosure relates to a target detection method. The target detection method according to this aspect comprises performing a supply of a transmission signal to a plurality of transmission elements sequentially from a start transmission element to an end transmission element, the plurality of transmission elements converting the transmission signal into a transmission wave; and controlling a sweep time, the sweep time being a time from the supply of the transmission signal to the start transmission element to the supply of the transmission signal to the end transmission element.

According to the target detection method of the second aspect, the sweep time of the transmission elements is controlled similarly to the above-described first aspect. Therefore, as for the first aspect, it is possible to easily adjust the searchable angular range of a device having a finite bandwidth.

A third aspect of the present disclosure relates to a non-transitory computer-readable medium having stored thereon computer-executable instructions which, when executed by a controller of a target detection device, cause the controller to perform a supply of a transmission signal to a plurality of transmission elements sequentially from a start transmission element to an end transmission element, the plurality of transmission elements converting the transmission signal into a transmission wave; and control a sweep time, the sweep time being a time from the supply of the transmission signal to the start transmission element to the supply of the transmission signal to the end transmission element.

According to the non-transitory computer-readable medium of the third aspect, the sweep time of the transmission elements is controlled similarly to the above-described first aspect. Therefore, as the first aspect, it is possible to easily adjust the searchable angular range of a device having a finite bandwidth.

The effect or significance of the present disclosure will be further clarified by the description of the following embodiments. However, the following embodiments are only examples of the embodiments of the present disclosure, and the present disclosure is not limited in any way to those described in the following embodiments.

### BRIEF DESCRIPTION OF DRAWINGS

FIG. 1 is a diagram showing a use of a target detection device according to an embodiment.

FIG. 2A and FIG. 2B are plan views schematically showing a configuration of a transducer according to an embodiment, respectively.

FIG. 3 is a diagram for explaining a relationship between frequency and angular direction of a transmission wave according to an embodiment.

FIG. 4 is a diagram showing a simulation result obtained by simulation of a surface in which a frequency of the transmission wave is equal, according to an embodiment.

FIG. 5 is a diagram schematically showing a configuration example of a transmission/reception system according to an embodiment.

FIG. 6 is a block diagram showing a configuration of the target detection device according to an embodiment.

FIG. 7 is a graph showing a relationship between the frequency of the transmission wave and a sweep direction angle in which each frequency occurs when a sweep time is varied, in a method of simultaneously supplying a transmission signal to three successive transmission elements, according to an embodiment.

FIG. 8 is a graph showing a relationship between the frequency of the transmission wave and the sweep direction angle in which each frequency occurs when the sweep time is varied, in the method of simultaneously supplying a transmission signal to three successive transmission elements, according to an embodiment.

FIG. 9 is a graph showing a relationship between the frequency of the transmission wave and the sweep direction angle in which each frequency occurs when the sweep time is varied, in the method of simultaneously supplying a transmission signal to three successive transmission elements, according to an embodiment.

FIG. 10 is a graph showing a relationship between the frequency of the transmission wave and the sweep direction angle in which each frequency occurs when a frequency of the transmission signal is varied, in the method of simultaneously supplying the transmission signal to three successive transmission elements, according to an embodiment.

FIG. 11 is a graph showing a relationship between the frequency of the transmission wave and the sweep direction angle in which each frequency occurs when the frequency of the transmission signal is varied, in the method of simultaneously supplying the transmission signal to three successive transmission elements, according to an embodiment.

FIG. 12 is a graph showing a relationship between the frequency of the transmission wave and the sweep direction angle in which each frequency occurs when the frequency of the transmission signal is varied, in the method of simultaneously supplying the transmission signal to three successive transmission elements, according to an embodiment.

FIG. 13 is a graph showing a relationship between the frequency of the transmission wave and the sweep direction angle in which each frequency occurs when the sweep time is varied, in a method of supplying the transmission signal to one transmission element, according to an embodiment.

FIG. 14 is a graph showing a relationship between the frequency of the transmission wave and the sweep direction angle in which each frequency occurs when the sweep time is varied, in the method of supplying the transmission signal to one transmission element, according to an embodiment.

FIG. 15 is a graph showing a relationship between the frequency of the transmission wave and the sweep direction angle in which each frequency occurs when the sweep time is varied, in the method of supplying the transmission signal to one transmission element, according to an embodiment.

FIG. 16 is a graph showing a relationship between the frequency of the transmission wave and the sweep direction angle in which each frequency occurs when the frequency of the transmission signal is varied, in the method of supplying the transmission signal to one transmission element, according to an embodiment.

FIG. 17 is a graph showing a relationship between the frequency of the transmission wave and the sweep direction angle in which each frequency occurs when the frequency of the transmission signal is varied, in the method of supplying the transmission signal to one transmission element, according to an embodiment.

FIG. 18 is a graph showing a relationship between the frequency of the transmission wave and the sweep direction angle in which each frequency occurs when the frequency of the transmission signal is varied, in the method of supplying the transmission signal to one transmission element, according to an embodiment.

FIG. 19 is a flowchart showing a display processing of an echo image according to an embodiment.

FIG. 20A and FIG. 20B are diagrams showing examples of configuration of a reception screen for accepting a change of an angular range (i.e., sweep time) according to an embodiment.

FIG. 21A and FIG. 21B are diagrams showing examples of configuration of a reception screen for accepting a change of a center angle (i.e., frequency of the transmission signal) according to an embodiment.

FIG. 22 is a flowchart showing a display processing of an echo image according to a first modification.

FIG. 23A and FIG. 23B are diagrams schematically showing setting examples of the center angle according to the first modification.

FIG. 24 is a diagram showing a method of supplying the transmission signal to the transmission elements according to a second modification.

FIG. 25A shows a configuration of a transmission array according to a third modification, and FIG. 25B shows a configuration of the transmission array and a switch according to a fourth modification.

### DETAILED DESCRIPTION

The functionality of the elements disclosed herein may be implemented using circuitry or processing circuitry which includes general purpose processors, special purpose processors, integrated circuits, ASICs (i.e., Application Specific Integrated Circuits), conventional circuitry and/or combinations thereof which are configured or programmed to perform the disclosed functionality. Processors are considered processing circuitry or circuitry as they include transistors and other circuitry therein.

In the disclosure, the circuitry, units, or means are hardware that carry out or are programmed to perform the recited functionality. The hardware may be any hardware disclosed herein or otherwise known which is programmed or configured to carry out the recited functionality.

When the hardware is a processor which may be considered a type of circuitry, the circuitry, means, or units are a combination of hardware and software, the software being used to configure the hardware and/or processor.

Embodiments of the present disclosure will now be described with reference to the drawings. The following embodiments show configuration in which a target detection device is used as a sonar for detecting a target in water.

In a conventional target detection device capable of transmitting a transmission wave whose frequency changes according to direction, a search range in which the target can be searched is limited by a bandwidth specific to the device. Such a bandwidth limit is based on, for example, an operational bandwidth of the transmission elements or the reception elements. Therefore, when it is necessary to adjust the search range, it is necessary to adjust the bandwidth specific to the device. However, such adjustment cannot be easily performed because it involves hardware changes.

The present disclosure is made in view of this situation, and one purpose thereof is to provide a target detection device and a target detection method capable of easily adjusting a searchable angular range of a device having a finite bandwidth.

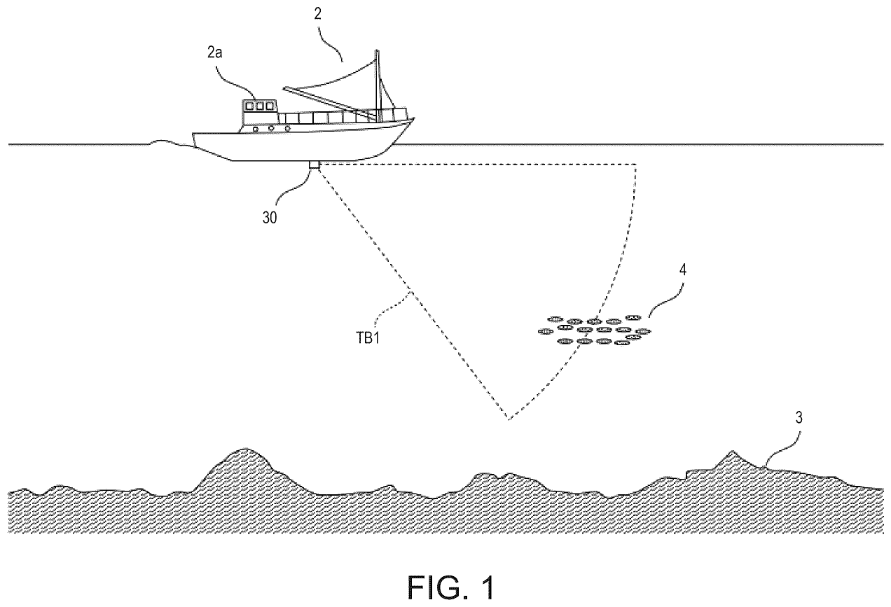

FIG. 1 is a diagram showing a use of the target detection device.

In an embodiment, a transducer 30 is installed on the bottom of a ship 2. The transducer 30 transmits a transmission beam (i.e., ultrasonic wave) TB1 into the water. The transducer 30 receives a reflection wave (i.e., echo) of the transmission beam TB1 reflected by sea bottom 3 and fish school 4 and outputs a reception signal. Based on the reception signal, the target detection device may generate an echo image showing an intensity distribution of the echo in the water and display it on a display. Configuration of the target detection device other than the transducer 30 and the display is provided on a control device installed in a wheelhouse 2a of the ship 2. The display is installed in the wheelhouse 2a separately from the control device. The display may also be integrated with the control device.

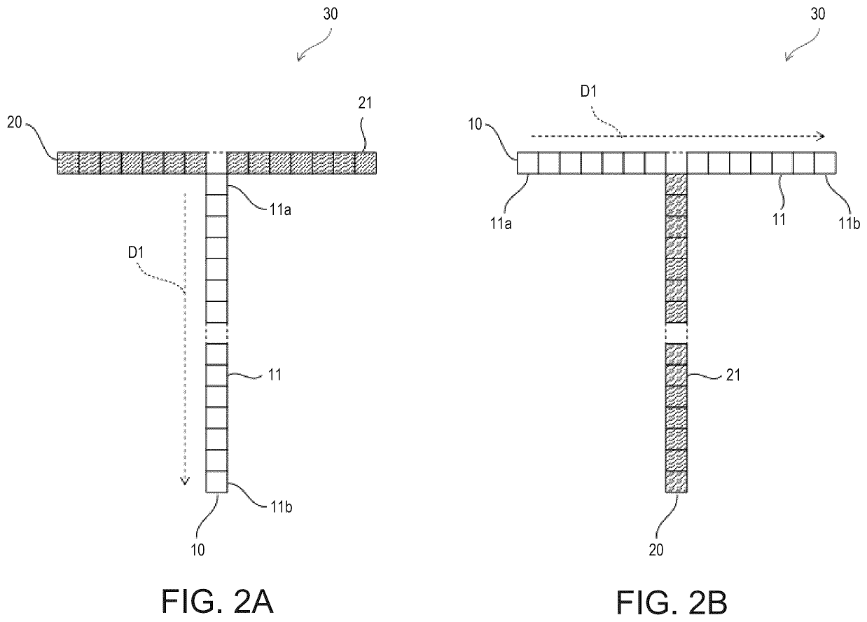

FIG. 2A and FIG. 2B are plan views schematically showing a configuration of the transducer 30.

The transducer 30 includes a transmission array 10 and a reception array 20. The transmission array 10 comprises a plurality of transmission elements 11 arranged in a row. The reception array 20 may comprise a plurality of reception elements 21 arranged in a row. The transmission elements 11 and the reception elements 21 are ultrasonic oscillators. A direction in which the plurality of transmission elements 11 are aligned and a direction in which the plurality of reception elements 21 are aligned may be substantially perpendicular to each other. The plurality of transmission elements 11 and the plurality of reception elements 21 may be arranged in the same plane. However, the arrangement of the plurality of transmission elements 11 and the plurality of reception elements 21 is not limited thereto. For example, the direction in which the plurality of transmission elements 11 are arranged and the direction in which the plurality of reception elements 21 are arranged may be 45°, 60°, or the like in plan view.

FIG. 2A shows an example of configuration of the transmission array 10 and the reception array 20 when the plurality of transmission elements 11 are arranged in a direction of elevation/depression angle (i.e., vertical direction). FIG. 2B shows an example of configuration of the transmission array 10 and the reception array 20 when the plurality of transmission elements 11 are arranged in a direction of azimuth angle (i.e., horizontal direction). The transmission signal is supplied to the plurality of transmission elements 11 sequentially from a start transmission element 11a to an end transmission element 11b. Thus, a transmission source (i.e., sound source) of a transmission wave moves in direction D1 in which the plurality of transmission elements 11 are arranged. Thus, a frequency of the transmission wave changes due to Doppler effect. In the configuration of FIG. 2A, the frequency of the transmission wave changes in the direction of the elevation/depression angle, and in the configuration of FIG. 2B, the frequency of the transmission wave changes in the direction of the azimuth angle.

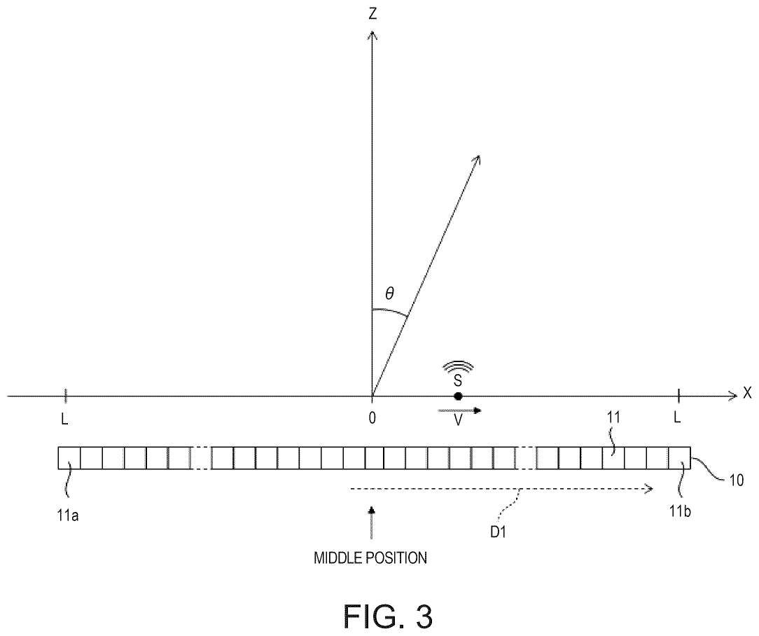

FIG. 3 is a diagram for explaining a relationship between the frequency of the transmission wave and a direction of angle θ.

The transmission signal is sequentially supplied to the plurality of transmission elements 11 constituting the transmission array 10 from the start transmission element 11a to the end transmission element 11b. As a result, the transmission source S (i.e., sound source) of the transmission wave moves in the moving direction D1, which is the direction in which the plurality of transmission elements 11 are arranged. As shown in the upper part of FIG. 3, when an X-axis is set in the moving direction D1, the transmission source S of the transmission wave moves in the X-axis direction by sequentially supplying the transmission signal from the start transmission element 11a to the end transmission element 11b. Here, the frequency of the transmission signal is constant.

A moving speed V of the transmission source S is higher as a sweep time, which is the time between supplying the transmission signal to the start transmission element 11a and supplying the transmission signal to the end 20) transmission element 11b, is shorter. In other words, the higher a sweep speed, which is the speed at which the transmission elements 11 supplied by the transmission signal are switched, the higher the moving speed V of the transmission source S.

As described above, when the transmission source S is moved in the moving direction D1, a frequency change based on the Doppler effect occurs in the transmission wave observed at an observation position at a predetermined distance from the transmission source S.

That is, when the distance between the transmission source S and the observation position is sufficiently large, the frequency change based on the Doppler effect does not occur at an observation position (hereinafter referred to as “front observation position”) located in the front direction (Z-axis direction) with respect to the middle position of the moving range, and the transmission wave with a frequency f₀ equal to the transmission signal occurs. On the other hand, at an observation position (hereinafter referred to as “negative observation position”) located in the opposite direction from the moving direction with respect to the front observation position, the transmission wave with a frequency lower than the frequency f₀ of the transmission signal occurs due to the Doppler effect because the transmission source S moves away from the observation position. Further, at an observation position (hereinafter referred to as “positive observation position”) located in the same direction as the moving direction with respect to the front observation position, the transmission wave with a frequency higher than the frequency f₀ of the transmission signal occurs due to the Doppler effect because the transmission source S moves in the direction approaching the observation position.

When the angle θ is set as shown in FIG. 3 with the angle inclined in the positive direction of the X axis with respect to the Z axis being positive, velocity c(θ) of the transmission wave in the direction of the angle θ from the middle position is expressed by the following equation from the moving speed V (unit: m/s) of the transmission source S and a reference velocity c₀ (unit: m/s) of the transmission wave in absence of the Doppler effect.

$$c ( θ ) = \frac{{c}_{0} - V sin ( θ )}{{c}_{0}} \qquad ( Equation 1 )$$

From this equation 1, the frequency of the transmission wave in the direction of the angle θ is expressed by the following equation.

$$f ( θ ) = \frac{{f}_{0}}{c ( θ )} = {f}_{0} \frac{{c}_{0}}{{c}_{0} - V sin ( θ )} ≅ {f}_{0} ( 1 + \frac{V sin ( θ )}{{c}_{0}} ) \qquad ( Equation 2 )$$

Therefore, when the reflection wave of the transmission wave is received by the reception elements 21, the angle θ can be specified by a frequency component of the reception signal outputted from the reception elements 21. In other words, by extracting a predetermined frequency component from the reception signal, a reception signal in the direction of the angle θ corresponding to the frequency component can be acquired. In this embodiment, the reception signal at each angular position is acquired based on this principle.

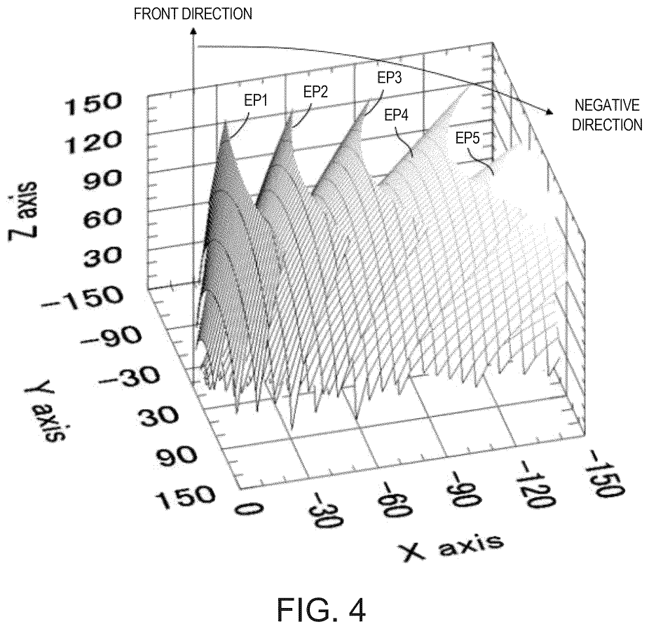

FIG. 4 is a diagram showing a simulation result obtained by simulation of a surface (hereinafter referred to as “equal-frequency surface”) having an equal frequency.

In FIG. 4, the unit of each axis is “meter”. The transmission array is arranged so as to extend in the X-axis direction at the middle position in the Y-axis direction (i.e., the position where the distance is zero). The transmission wave is transmitted in the Z-axis direction from the middle position in the Y-axis direction. That is, the direction from the middle position in the Y-axis direction to the Z-axis direction is the front direction.

FIG. 4 shows equal-frequency surfaces EP1 to EP5 in a range where the angle θ is more negative than the front direction. The equal-frequency surfaces EP1, EP2, EP3, EP4, and EP5 are each lower than the frequency f₀ in the front direction. As to a magnitude of the frequency, the equal-frequency surfaces EP1, EP2, EP3, EP4, and EP5 have the relationship EP1>EP2>EP3>EP4>EP5.

For convenience, five equal-frequency surfaces EP1 to EP5 are shown in FIG. 4, but there are many equal-frequency surfaces between these equal-frequency surfaces EP1 to EP5. For example, the frequency of the gap between the equal-frequency surfaces EP1 and EP2 continuously transitions from the frequency of the equal-frequency surface EP1 to the frequency of the equal-frequency surface EP2. The equal-frequency surfaces EP1 to EP5 shown in FIG. 4 are folded symmetrically about the Y-Z plane to form equal-frequency surfaces in a range on a positive side from the front direction.

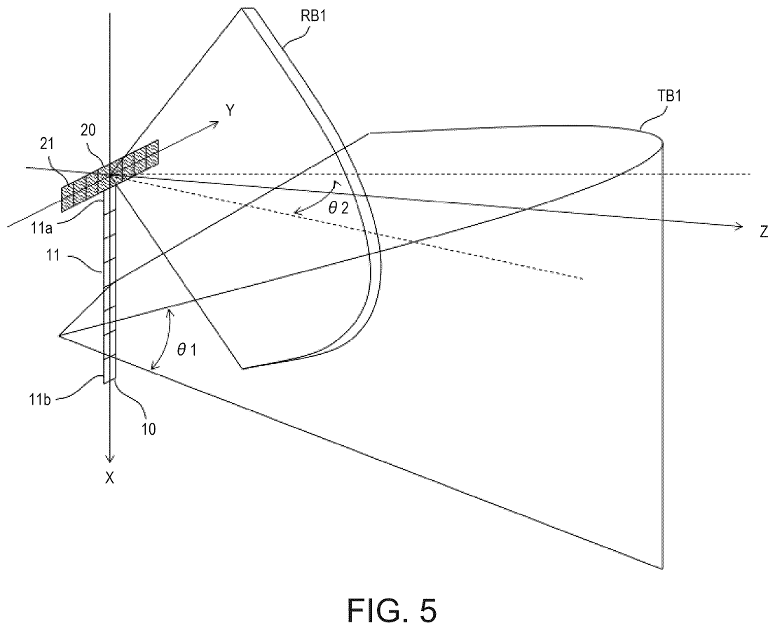

FIG. 5 is a diagram schematically showing a configuration example of a transmission/reception system.

In the example of FIG. 5, the transmission array 10 and the reception array 20 of the configuration of FIG. 2A are used. Alternatively, the transmission array 10 and the reception array 20 of the configuration of FIG. 2B may be used.

By sequentially driving the transmission elements 11 in the transmission array 10 from the start transmission element 11a to the end transmission element 11b as described above, the transmission beam TB1 is formed in front of the transmission array 10 (i.e., in the Z-axis positive direction).

That is, when the transmission signal is supplied to the transmission elements 11, the transmission wave is transmitted from the transmission elements 11 with a relatively wide directivity. When the transmission signal is supplied to the transmission elements 11 in the transmission array 10 in order from the start transmission element 11a to the end transmission element 11b, a region where all the transmission waves transmitted from each transmission element 11 overlap becomes the region of the transmission beam TB1. In this region, as described with reference to FIG. 4, a large number of equal-frequency surfaces are generated.

By performing phase control (i.e., beamforming) on the reception signal outputted from each reception element 21, a reception beam RB1 having a narrow width in the circumferential direction around the X-axis may be formed. Thus, the reception signal in a region where the reception beam RB1 and the transmission beam TB1 intersect may be extracted. By performing the phase control, the reception beam RB1 may be rotated in θ2 direction around the X-axis to extract the reception signal at each rotated position. From the rotated position of the reception beam RB1, an arrival direction in the Y-Z plane of the reflection wave whose transmission wave is reflected by the target can be defined. The frequency of the reception signal can also define the equal-frequency surface (see FIG. 4) on which the reflection wave is generated.

Therefore, among the reception signals extracted by the reception beam RB1, the reception signals of frequencies corresponding to each equal-frequency surface may be extracted, and an intensity of the extracted reception signals on each equal-frequency surface may be plotted on each equal-frequency surface to obtain a distribution of intensity data of the reception signals in the range where the reception beam RB1 and the transmission beam TB1 intersect. Then, the reception beam RB1 may be rotated within the detection range around the X-axis to obtain the distribution of intensity data at each rotated position, so that intensity data (i.e., volume data) distributed in a three-dimensional manner in all detection ranges in the Y-axis direction and X-axis direction can be obtained. By imaging the intensity data (i.e., volume data), an image showing a state of the target in the detection range can be obtained.

The transducer 30 described above is installed so that, for example, the Y-axis direction in FIG. 5 is a horizontal direction. In this case, the transducer 30 may be installed so that the X-axis direction in FIG. 5 is inclined by a predetermined angle with respect to the vertical direction so that the transmission beam TB1 is directed to the sea bottom 3. As a result, the intensity data (i.e., volume data) distributed in a three-dimensional manner in the detection range in the horizontal and vertical directions are acquired.

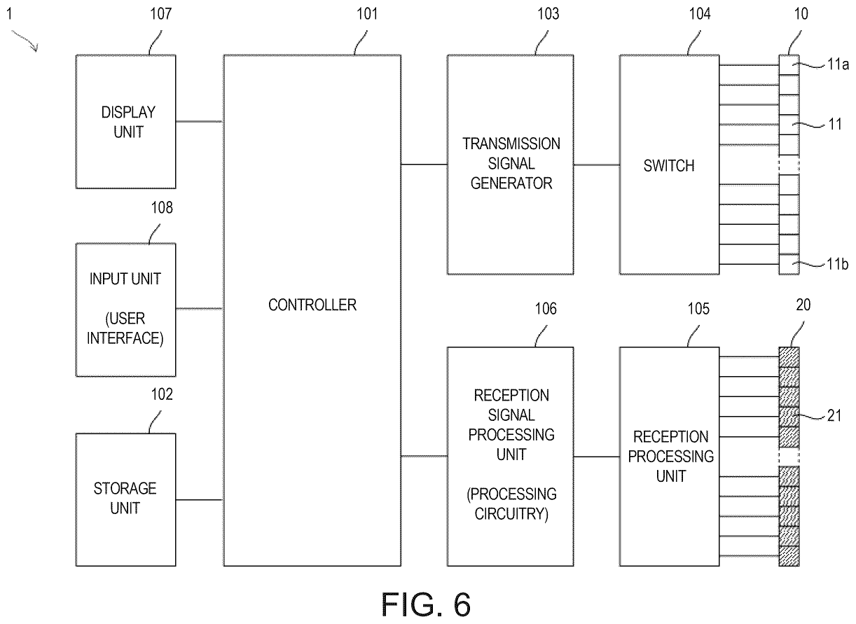

FIG. 6 is a block diagram showing a configuration of a target detection device 1.

The target detection device 1 may include a controller 101, a storage unit 102, a transmission signal generator 103, a switch 104, a reception processing unit 105, a reception signal processing unit 106 (which may also be referred to as processing circuitry 106), a display unit 107, and an input unit 108 (which may also be referred to as a user interface 108).

The controller 101 may include an arithmetic processing circuitry such as a CPU (i.e., Central Processing Unit) and control each unit according to a program stored in the storage unit 102. The controller 101 may include an integrated circuit such as a field-programmable gate array (i.e., FPGA). The storage unit 102 may include a storage medium such as a ROM (i.e., Read Only Memory) or a RAM (i.e., Random Access Memory) and store the program. The storage unit 102 may also be used as a work area for controlling the controller 101.

The transmission signal generator 103 generates the transmission signal in response to a control from the controller 101. The switch 104 sequentially supplies the transmission signal to the plurality of transmission elements 11 included in the transmission array 10 from the start transmission element 11a to the end transmission element 11b in response to a control from the controller 101. As a result, the transmission beam TB1 shown in FIG. 5 is formed, and the equal-frequency surfaces (see FIG. 4) are formed in the transmission beam TB1. The switch 104 is composed of, for example, a demultiplexer.

The reception processing unit 105 is connected to the plurality of reception elements 21 included in the reception array 20. The reception processing unit 105 may perform a process for removing unnecessary bandwidth, a process for amplifying the reception signal to a level suitable for AD conversion, a process for removing signal components in a band half or more of the sampling period of the AD conversion, and the like with respect to the reception signals inputted from the respective reception elements 21. Further, the reception processing unit 105 may convert the thus processed reception signal for each of the reception elements 21 into a digital signal at a predetermined sampling period and output it to the reception signal processing unit 106.

The reception signal processing unit 106 processes the reception signal for each of the reception elements 21 inputted from the reception processing unit 105 and may calculate the intensity data (i.e., volume data) of the reception signals distributed in the three-dimensional manner in the detection range. The calculation processing of the volume data may be as described with reference to FIGS. 4 and 5. The reception signal processing unit 106 may be integrated with the controller 101 into a single integrated circuit (such as an FPGA).

The controller 101 may process the intensity data (i.e., volume data) inputted from the reception signal processing unit 106 to generate image data that images the state of the target within the detection range. The controller 101 may output the generated image data to the display unit 107. The display unit 107 may comprise a monitor or the like and display the image data inputted from the controller 101. The input unit 108 is a user interface and may include an input means such as a trackball and outputs inputted information to the controller 101. The input unit 108 may be a transparent touchpad superposed on the display unit 107.

In the target detection device I having the above configuration, a range of the angles θ (i.e., the range of the angle θ1 in FIG. 5) in which the target can be searched is limited by a bandwidth specific to the device. Such a bandwidth limit is based, for example, on an operable bandwidth of the transmission elements 11 or the reception elements 21. For example, if a frequency band in which the reception elements 21 can receive the reflection wave and output the reception signal is 400˜660 kHz, an angular range corresponding to this frequency band is the range in which the frequency of the transmission wave can be changed according to Equation 2. Therefore, when it is necessary to adjust the angular range in which the search can be performed, it is necessary to adjust the bandwidth specific to the device. However, such adjustment cannot be easily performed because it involves hardware changes.

In view of this problem, the present embodiments use a configuration in which the range of the angles θ that can be searched with a device having a finite frequency band can be easily adjusted. This configuration is described below.

First, a relationship between the frequency band of the transmission wave and the angle θ shown in FIG. 3 is explained.

From Equation 2 above, it can be seen that a frequency distribution in the transmission beam TB1 is changed by changing the moving speed V of the transmission source S. Therefore, the frequency distribution in the transmission beam TB1 can be changed by changing the time (that is, the sweep time of the switch 104) for sequentially supplying the transmission signal to the plurality of transmission elements 11 included in the transmission array 10 from the start transmission element 11a to the end transmission element 11b.

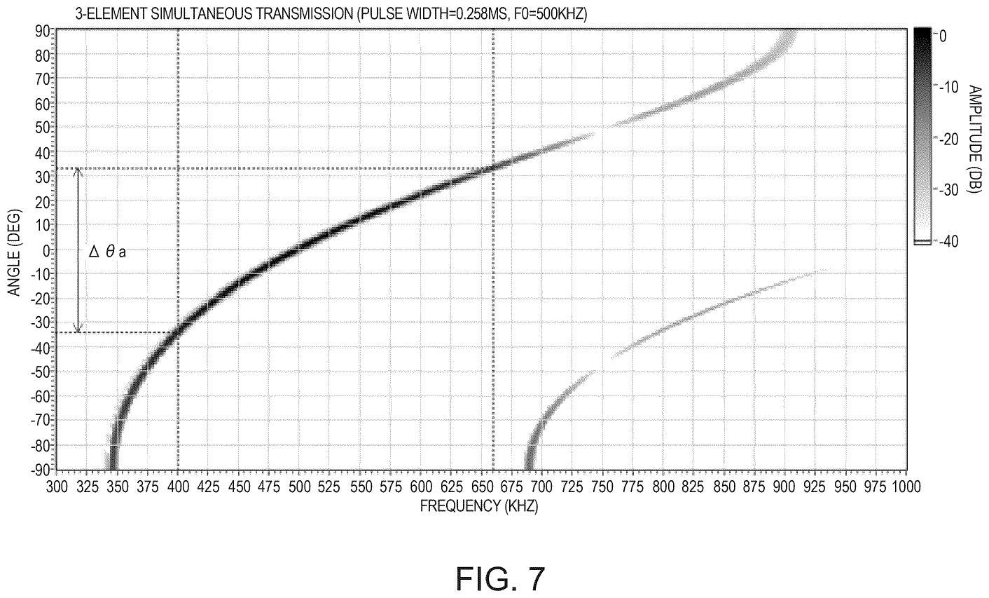

FIGS. 7 to 9 are graphs showing a relationship between the frequency of the transmission wave and the sweep direction angle θ in which each frequency occurs when the sweep time is changed.

These graphs are based on simulation. The simulation conditions are as follows.
Reference velocity c₀=1500 m/s
Frequency of the transmission signal f₀=500 kHz
Number of transmission elements=128.
Transmission element pitch=0.45λ (λ is the wavelength of the transmission signal)
Sampling frequency=40,000 kHz
Number of observation points=181 (Pitch 1°, Start Angle −90°)

In FIGS. 7 to 9, the horizontal axis is the frequencies included in the transmission beam TB1, and the vertical axis is the angle θ corresponding to each frequency. In addition, a frequency spectrum amplitude at each frequency is indicated by a color scale on the right. The sweep time is indicated in the upper left corner of the graphs as pulse width.

In the simulation of FIGS. 7 to 9, the transmission signal is simultaneously supplied to three adjacent transmission elements 11. In other words, when the start transmission element 11a is the first transmission element 11, the transmission signal is simultaneously supplied to the first to third transmission elements 11, and then to the second to fourth transmission elements 11. Thereafter, while shifting the three transmission elements 11 to be supplied with the transmission signal by one element, the transmission signal is simultaneously supplied to three transmission elements 11, and the same process is repeated until the three transmission elements 11 reach the end transmission element 11b.

In this way, when the three transmission elements 11 supplied with the transmission signal are shifted by one element, influence of noise (i.e., spurious) on each frequency component of the transmission beam TB1 can be suppressed and transmission power can be increased compared with a case where the transmission signal is sequentially supplied to one transmission element 11. However, on the other hand, a directivity of a sweep direction (i.e., the moving direction D1 of the transmission source S) of the transmission wave transmitted from the three transmission elements 11 becomes narrower than the directivity of the sweep direction of the transmission wave transmitted from one transmission element 11. Therefore, in order to widen the directivity of the transmission wave in the sweep direction, it is preferable to supply the transmission signal from the start transmission element 11a to the end transmission element 11b one element at a time.

FIG. 7 shows the relationship between the frequency and the angle θ when the sweep time (i.e., pulse width) is 0.258 ms. In this case, when the finite frequency band of the device is 400˜660 kHz, the range (i.e., angular range) Δθa of the searchable angles θ is about −34° to +33°.

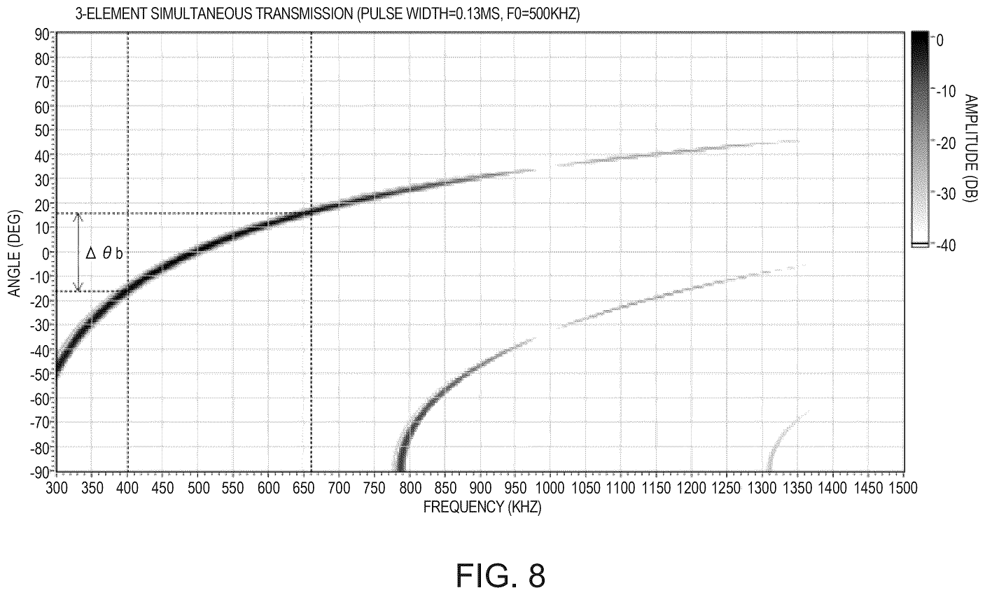

FIG. 8 shows the relationship between the frequency and the angle θ when the sweep time (i.e., pulse width) is 0.13 ms. In this case, when the finite frequency band of the device is 400˜660 kHz, the range (i.e., angular range) Δθb of the searchable angles θ is about −16° to +16°.

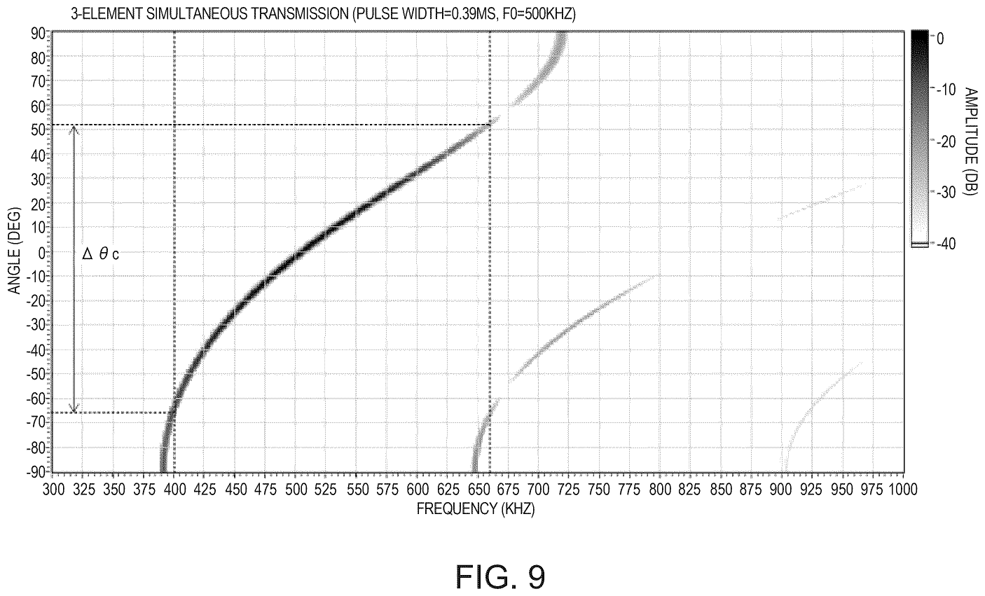

FIG. 9 shows the relationship between the frequency and the angle θ when the sweep time (i.e., pulse width) is 0.39 ms. In this case, when the finite frequency band of the device is 400˜660 kHz, the range (i.e., angular range) Δθc of the searchable angles θ is about −66° to +52°.

From simulation results of FIGS. 7 to 9, it can be seen that the range of the angles θ that can be searched can be changed by changing the sweep time (i.e., pulse width). The longer the sweep time (i.e., pulse width), the wider the range of the angles θ that can be searched with a device having a finite frequency band.

The shorter the sweep time (i.e., pulse width), the narrower the range of the angles θ that can be searched with a device having a finite frequency band.

On the other hand, the longer the sweep time (i.e., pulse width), the worse a distance resolution of target detection. For example, when the sweep time (i.e., pulse width) is 0.258 ms as shown in FIG. 7, the distance resolution is about 193.5 mm. On the other hand, when the sweep time (i.e., pulse width) is 0.13 ms as shown in FIG. 8, the distance resolution is about 97.5 mm, and when the sweep time (i.e., pulse width) is 0.39 ms as shown in FIG. 9, the distance resolution is about 292.5 mm.

Thus, there is a trade-off between the angular range that can be searched and the distance resolution. Therefore, depending on whether a user prefers the angular range that can be searched or the distance resolution, the sweep time should be changed accordingly. Thus, target detection according to the user's request can be easily performed.

Further, by changing the frequency f₀ of the transmission signal among parameters in Equation 2, a center angle of the range of the angles θ that can be searched may be further changed.

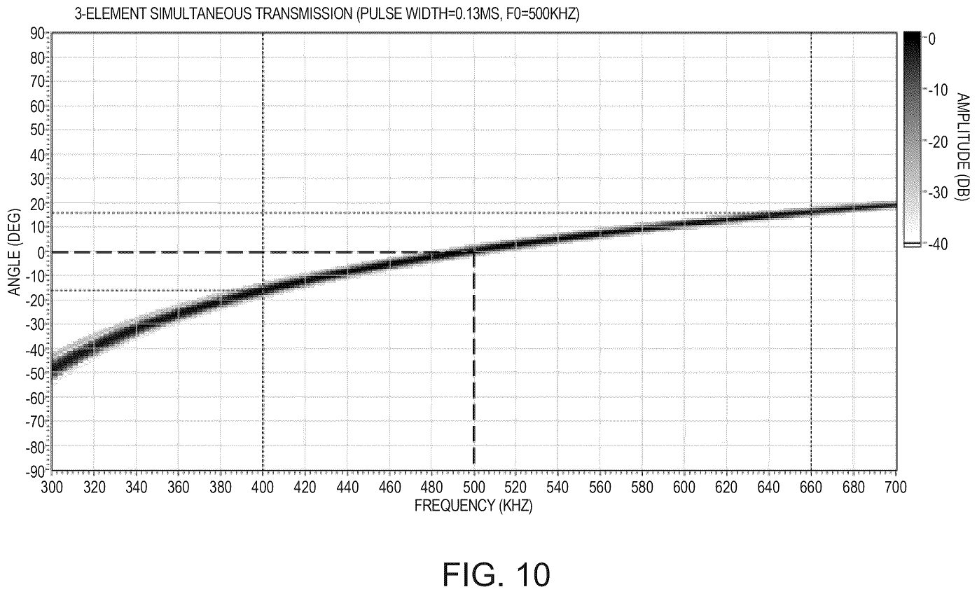

FIGS. 10 to 12 are graphs showing the relationship between the frequency of the transmission wave and the sweep direction angle θ in which each frequency occurs when the frequency f₀ of the transmission signal is changed.

FIG. 10 is a graph obtained by extracting a range of frequencies 300˜700 kHz from the graph of FIG. 8. The simulation conditions of FIG. 10 are the same as those of FIG. 8. In this case, the center angle of the range of searchable angles θ is 0°, and that angle corresponds to 500 kHz, which is the frequency f₀ of the transmission signal.

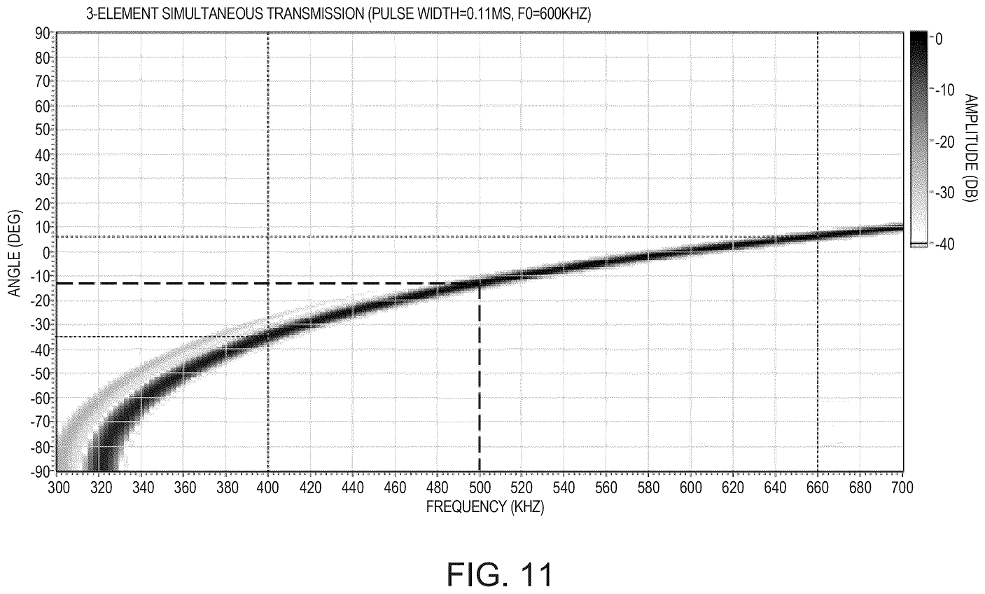

FIG. 11 is a graph when the frequency f₀ of the transmission signal is changed to 600 kHz. The vertical and horizontal axes are the same as those in FIG. 10. Here, the sweep time (i.e., pulse width) is slightly adjusted from that in FIG. 10 to suppress noise. Other simulation conditions are the same as those in FIG. 10. In this case, the center angle of the range of searchable angles θ is about −13°, and that angle corresponds to 500 kHz on the horizontal axis. In this case, the range of searchable angles θ is slightly wider than that in FIG. 10.

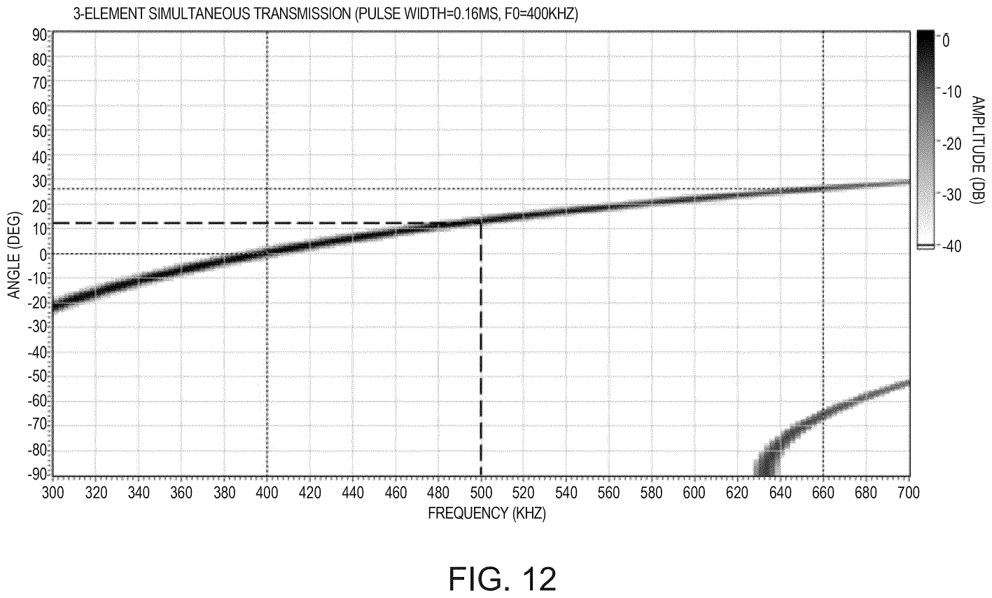

FIG. 12 is a graph when the frequency f₀ of the transmission signal is changed to 400 kHz. The vertical and horizontal axes are the same as those in FIG. 10. Here, the sweep time (i.e., pulse width) is slightly adjusted from that in FIG. 10 to suppress noise. Other simulation conditions are the same as those in FIG. 10. In this case, the center angle of the range of searchable angles θ is about +12°, and that angle corresponds to 500 kHz on the horizontal axis. In this case, the range of searchable angles θ is slightly narrower than that in FIG. 10.

As shown in FIGS. 10 to 12, the center angle of the range of searchable angles θ may be further changed by changing the frequency f₀ of the transmission signal. Therefore, it is necessary to change the frequency f₀ of the transmission signal appropriately to enable the user to detect a desired angular range. Thus, target detection according to the user's request can be performed more effectively.

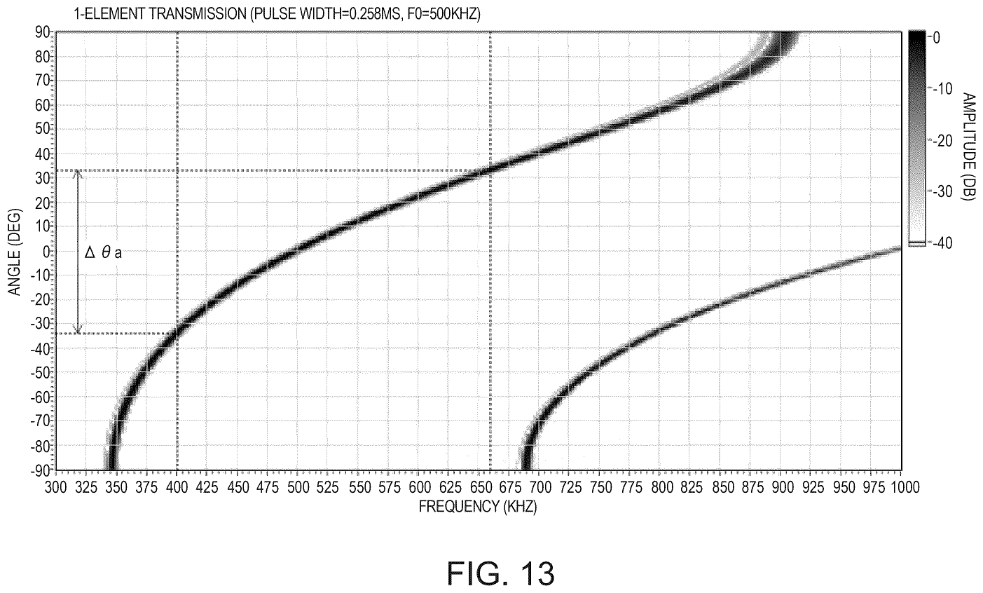

FIGS. 13 to 15 are graphs showing the relationship between frequency and angle θ when the transmission signal is sequentially supplied from the start transmission element 11a to the end transmission element 11b, one element at a time.

These graphs are also based on simulation, as the graphs in FIGS. 7 to 9. The simulation conditions are the same as those in FIGS. 7 to 9. The graphs in FIGS. 13 to 15 differ from those in FIGS. 7 to 9 in that the transmission signal is sequentially supplied to the plurality of transmission elements 11 included in the transmission array 10 from the start transmission element 11a to the end transmission element 11b, one element at a time.

FIG. 13 shows a graph when the sweep time (i.e., pulse width) is 0.258 ms. This sweep time corresponds to the case of FIG. 7. In the graph of FIG. 13, the width of the curve is thicker than that of FIG. 7 because of the effect of noise (i.e., spurious). However, the range 40a of the searchable angles θ is the same as that of FIG. 7.

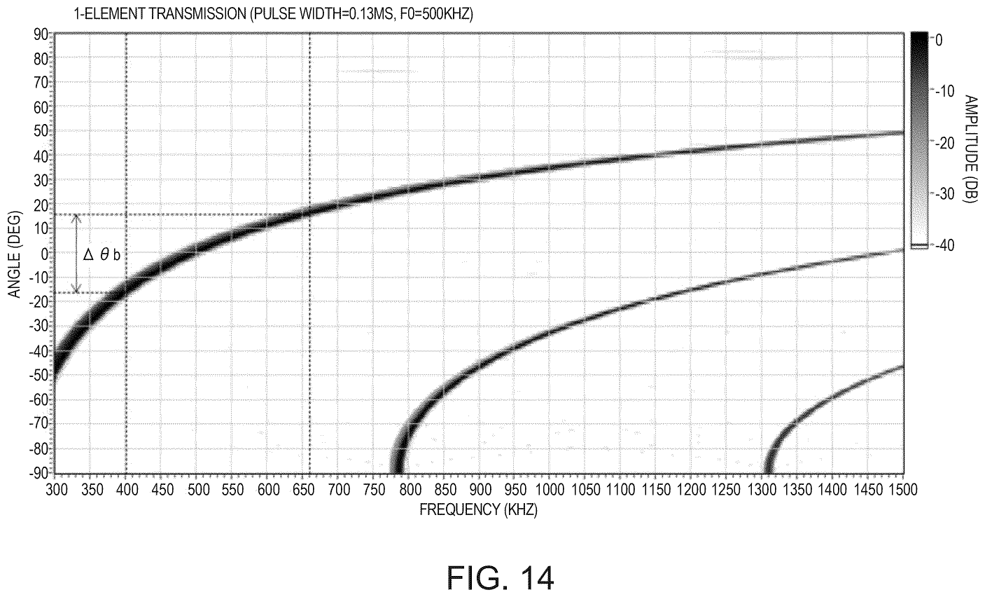

FIG. 14 shows a graph when the sweep time (i.e., pulse width) is 0.13 ms. This sweep time corresponds to the case of FIG. 8. In the graph of FIG. 14, the width of the curve is thicker than that of FIG. 8 because of the effect of noise (i.e., spurious). However, the range Δθb of the searchable angles θ is the same as that of FIG. 8.

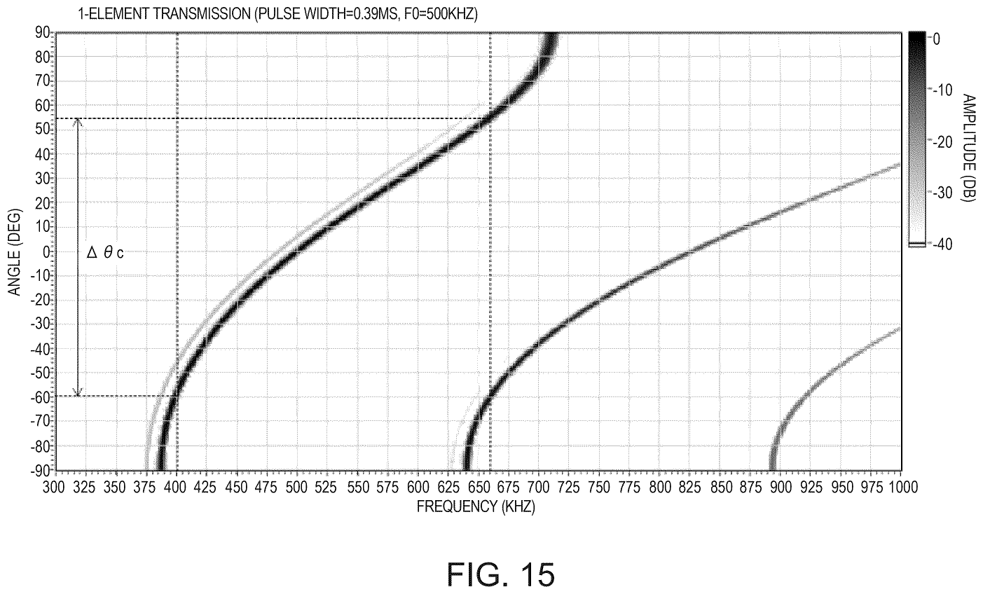

FIG. 15 shows a graph when the sweep time (i.e., pulse width) is 0.39 ms. This sweep time corresponds to the case of FIG. 9. In the left curve among the three curves of FIG. 15, a side curve is generated on the side due to noise (i.e., spurious). However, the range Δθc of the searchable angles θ is similar to that in FIG. 9.

Thus, even when the transmission signal is supplied one element at a time in order, the range of the searchable angles θ can be changed by changing the sweep time (i.e., pulse width). In this case, as in the case of FIGS. 7 to 9, there is a trade-off between the searchable angles θ and the distance resolution. Therefore, in this case as well, the sweep time may be appropriately changed according to whether the user prefers the angular range that can be searched or the distance resolution. Thus, target detection according to the user's request may be easily performed.

As described above, in the case of FIGS. 13 to 15, the directivity of the transmission wave in the sweep direction may be expanded compared with the case where the transmission signal is supplied simultaneously to three transmission elements 11 as shown in FIGS. 7 to 9. Therefore, in the case of expanding the directivity of the transmission wave in the sweep direction, it is preferable to supply the transmission signal sequentially one element at a time in order from the start transmission element 11a to the end transmission element 11b, as shown in FIGS. 13 to 15.

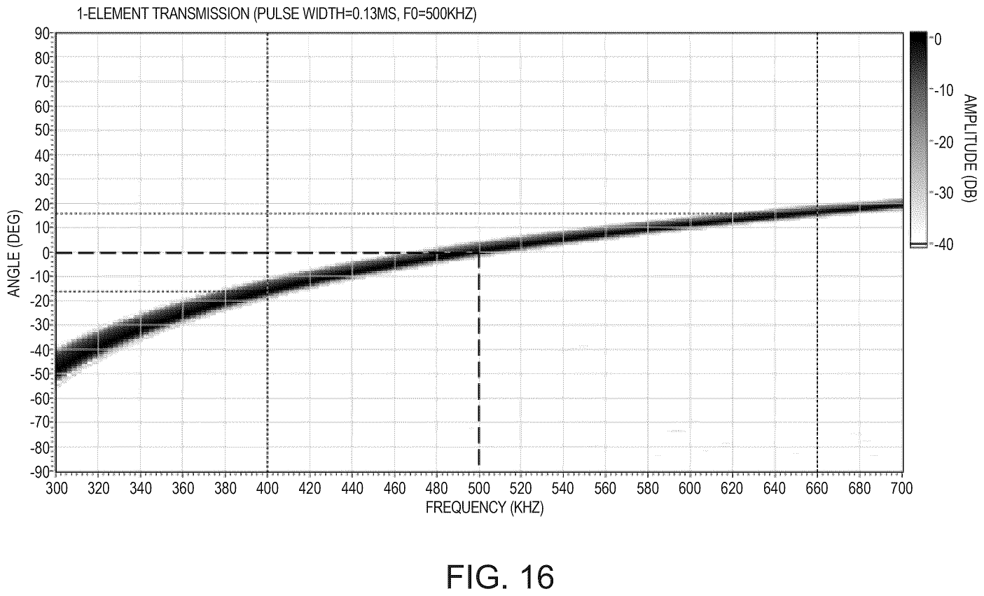

FIGS. 16 to 18 are graphs showing the relationship between the frequency of the transmission wave and the angle θ when the frequency f₀ of the transmission signal is changed.

FIG. 16 is a graph obtained by extracting the range of frequencies 300˜700 kHz from the graph of FIG. 14. The simulation conditions of FIG. 16 are the same as those of FIG. 14. In this case, the center angle of the range of searchable angles θ is 0°, and that angle corresponds to 500 kHz, which is the frequency f₀ of the transmission signal.

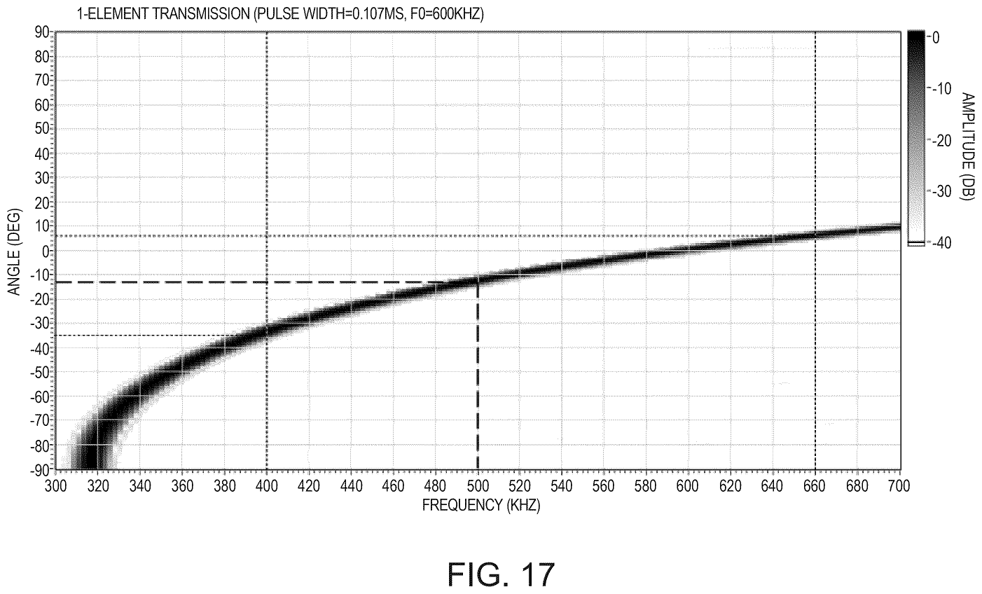

FIG. 17 is a graph when the frequency f₀ of the transmission signal is changed to 600 kHz. The vertical and horizontal axes are the same as those in FIG. 16. Here, the sweep time (i.e., pulse width) is slightly adjusted from that in FIG. 16 to suppress noise. Other simulation conditions are the same as those in FIG. 16. In this case, the center angle of the range of searchable angles θ is about −13°, and that angle corresponds to 500 kHz on the horizontal axis. In this case, the range of searchable angles θ is slightly wider than that in FIG. 16.

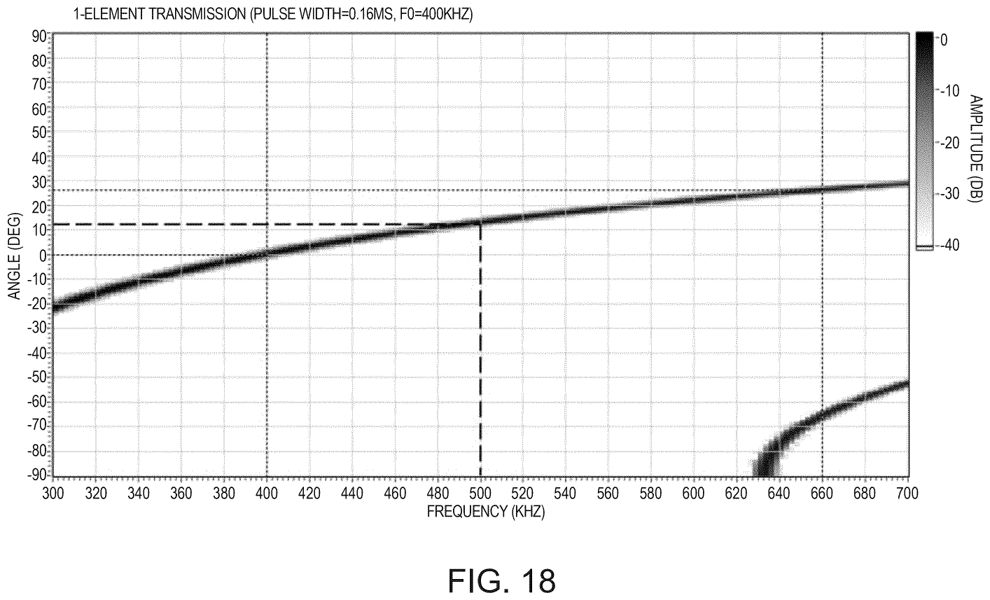

FIG. 18 is a graph when the frequency f₀ of the transmission signal is changed to 400 kHz. The vertical and horizontal axes are the same as those in FIG. 16. Here, the sweep time (i.e., pulse width) is slightly adjusted from that in FIG. 16 to suppress noise. Other simulation conditions are the same as those in FIG. 16. In this case, the center angle of the range of searchable angles θ is about +12°, and that angle corresponds to 500 kHz on the horizontal axis. In this case, the range of searchable angles θ is slightly narrower than that in FIG. 16.

As shown in FIGS. 16 to 18, even in the case where the transmission signal is sequentially supplied to each transmission element 11, the center angle of the range of searchable angles θ may be changed by changing the frequency f₀ of the transmission signal. Therefore, in this case as well, the frequency f₀ of the transmission signal may be appropriately changed in order to enable the user to detect the desired angular range. As a result, target detection according to the user's request may be performed more effectively.

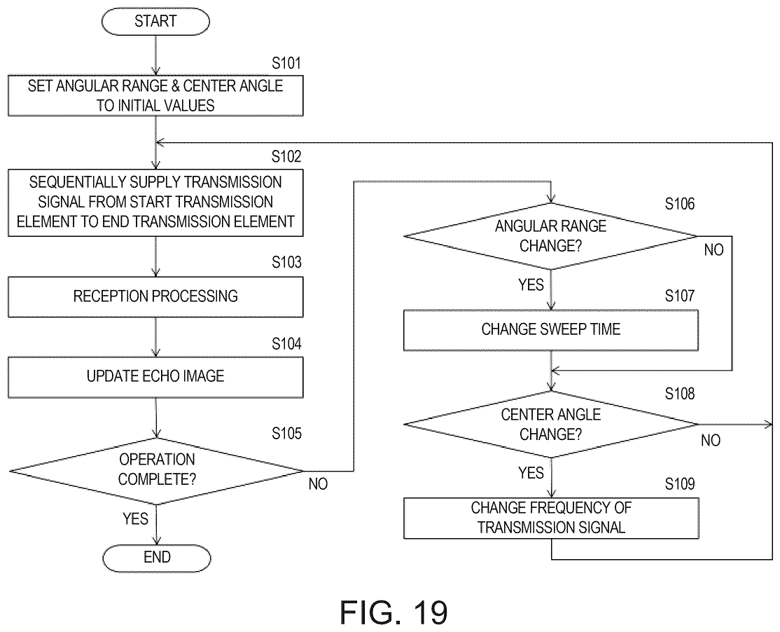

FIG. 19 is a flowchart showing a display processing of the echo image. When operation of the target detection device 1 starts, the controller 101 may set the range of the angles θ (i.e., sweep time) and the center angle (i.e., frequency f₀ of the transmission signal) of the transmission beam TB1 in the sweep direction to initial values, at step S101. Then, the controller 101 may transmit the transmission wave based on the set initial values. Specifically, the controller 101 controls the transmission signal generator 103 and the switch 104 so that the transmission signal is sequentially supplied to the plurality of transmission elements 11 included in the transmission array 10 from the start transmission element 11a to the end transmission element 11b, at step S102.

Here, the transmission signal may be supplied simultaneously to a plurality of adjacent transmission elements 11 as shown in FIGS. 7 to 9 or may be sequentially supplied to each transmission element 11 as shown in FIGS. 13 to 15.

In accordance with the transmission of the transmission wave in step S102, the controller 101 may cause the reception processing unit 105 and the reception signal processing unit 106 to process the reception signals outputted from the plurality of reception elements 21 included in the reception array 20 and acquire the intensity data (i.e., volume data) distributed in the detection range, at step S103. The controller 101 may update the echo image displayed on the display unit 107 with the acquired intensity data (i.e., volume data), at step S104.

In parallel with the processing in steps S102 to S103, the controller 101 may receive input from the user for changing the range of the angles θ (i.e., sweep time) and the center angle (i.e., frequency f₀ of the transmission signal) of the transmission beam TB1 in the sweep direction. When the processing of one sequence in steps S102 to S104 is completed, the controller 101 may determine whether the user has inputted changes to the angular range, at step S106 or to the center angle, at step S108.

If neither input is provided (step S106: NO, step S108: NO), the controller 101 may return the processing to step S102 and perform the processing of the next sequence.

On the other hand, if an input for changing the angular range is provided (step S106: YES), the controller 101 may change the sweep time used for the processing to the sweep time corresponding to the inputted angular range, at step S107. If an input for changing the center angle is provided (step S108: YES), the controller 101 may change the frequency of the transmission signal to the frequency corresponding to the inputted center angle, at step S108. Then, the controller 101 may return the processing to step S102 and perform processing of the next sequence with the newly set angular range or center angle.

Thus, the controller 101 may repeatedly execute the processes of steps S102 to S104 and steps S106 to S109 until the operation of the target detection device 1 is completed (step S105: NO). When the angular range or the center angle is changed in the processes of steps S106 to S109, the echo image displayed on the display unit 107 may be updated to an image corresponding to the angular range or the center angle after the change. After that, when the operation of the target detection device 1 is completed (step S105: YES), the controller 101 may terminate the process of FIG. 19.

In the process of FIG. 19, the initial values of the step S101 may be, for example, as shown in FIG. 7, the sweep time that corresponds to the angular range of about ±35° (i.e., sweep time=0.258 ms in FIG. 7) and the frequency of the transmission signal that corresponds to the center angle of about 0° (i.e., f₀=500 kHz in FIG. 7). Alternatively, the initial values of the step S101 may be the sweep time and the frequency of the transmission signal corresponding to the angular range and the center angle set at the end of the previous operation of the target detection device 1.

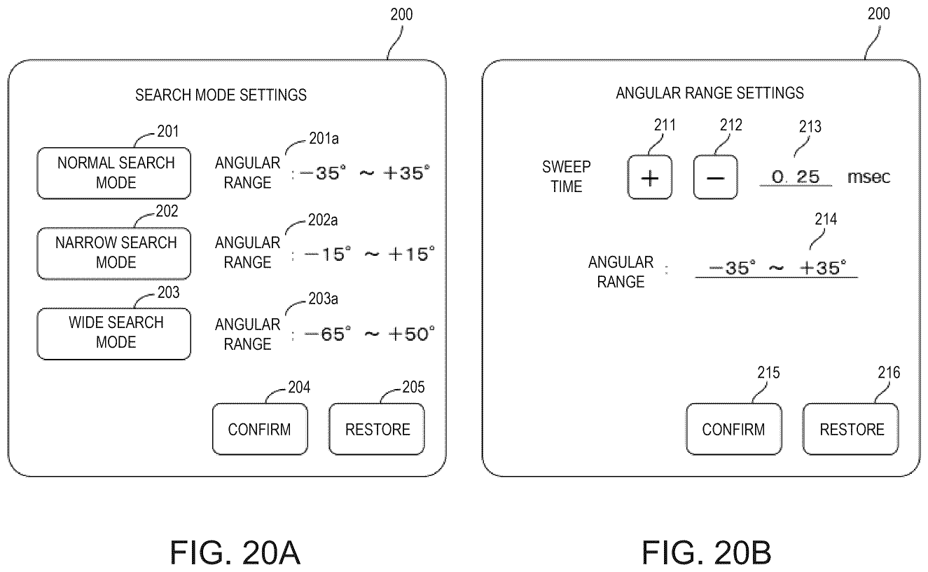

FIG. 20A and FIG. 20B are diagrams showing examples of configuration of a reception screen 200 for accepting a change in the angular range (i.e., sweep time).

These reception screens 200 may be displayed on the display unit 107 when the user selects a change mode of the angular range through the input unit 108. The user may interact with these reception screens 200 via the input unit 108.

In the configuration example of FIG. 20A, three pre-prepared angular ranges may be selected. The reception screen 200 may include three selection buttons 201˜203 corresponding to the three angular ranges. A normal search mode may be associated with the selection button 201, and an angular range of −35° to +35° may be assigned. A narrow search mode may be associated with the selection button 202, and an angular range of −15° to +15° may be assigned. A wide search mode may be associated with the selection button 203, and an angular range of −65° to +50° may be assigned.

Displays 201a to 203a indicating the angular range in each mode may be arranged on the right side of the three selection buttons 201˜203. The user can grasp the angular ranges assigned to the three selection buttons 201˜203 by referring to these displays 201a to 203a. The reception screen 200 may further include a confirmation button 204 for confirming the selection of the selection buttons 201˜203 and a button 205 for restoring the screen.

When any of the selection buttons 201˜203 is selected and the confirmation button 204 is operated, the determination in step S106 of FIG. 19 becomes YES. When the selection button 201 is selected, the sweep time (e.g., 0.258 ms in the example of FIG. 7) corresponding to the angular range of −35° to +35° is set in step S107 of FIG. 19. When the selection button 202 is selected, the sweep time (e.g., 0.13 ms in the example of FIG. 8) corresponding to the angular range of −15° to +15° is set in step S107 of FIG. 19. When the selection button 203 is selected, the sweep time (e.g., 0.39 ms in the example of FIG. 9) corresponding to the angular range of −65° to +50° is set in step S107 of FIG. 19.

Note that in the configuration example of FIG. 20A, there are three angular ranges that can be selected, but the number of angular ranges that can be selected is not limited to this. Each angular range is also an example, and upper and lower limits of the angular ranges that can be selected can be changed accordingly.

In the configuration example of FIG. 20B, the angular range (i.e., sweep time) can be arbitrarily set. The reception screen 200 may include an up button 211 for increasing the sweep time and a down button 212 for decreasing the sweep time. A value of a display item 213 corresponding to the sweep time may increase or decrease in response to an operation of the up button 211 or the down button 212, and accordingly, a value of a display item 214 corresponding to the angular range may increase or decrease. The reception screen 200 may further include a confirmation button 215 for confirming the sweep time and a button 216 for restoring the screen.

The user may operate the up button 211 and the down button 212 until the value of the display item 214 reaches a desired angular range and then operate the confirmation button 215. As a result, the determination in step S106 of FIG. 19 becomes YES. In this case, the sweep time displayed in the display item 213 at the time of the confirmation operation is set in step S107 of FIG. 19.

In the configuration example of FIG. 20B, for example, a table for associating the sweep time displayed in the display item 213 with the angular range displayed in the display item 214 may be previously stored in the storage unit 102 of FIG. 6. In this case, even if there is not necessarily an association between the angular ranges and all the possible sweep times, for example, a predetermined number of sets of sweep time/angular range may be stored in the storage unit 102, and the angular range/sweep time associations other than these sets may be calculated from these sets by interpolation operation. On the other hand, in the configuration example of FIG. 20A, the angular ranges and sweep times of each mode may be stored in the storage unit 102.

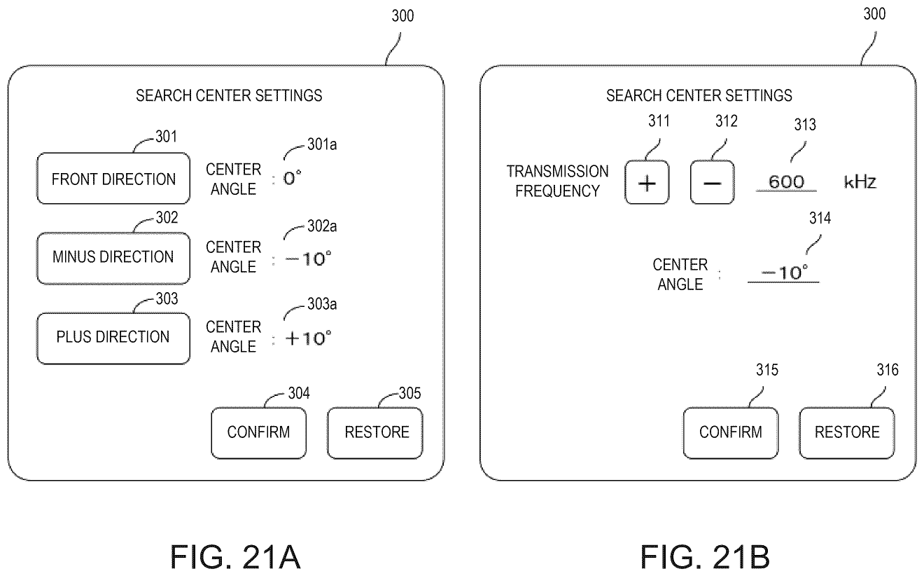

FIG. 21A and FIG. 21B are diagrams showing examples of configuration of a reception screen 300 for accepting a change in the center angle (i.e., frequency of the transmission signal).

These reception screens 300 may be displayed on the display unit 107 when the user selects a change mode of the center angle through the input unit 108. The user may interact with these reception screens 300 via the input unit 108.

In the configuration example of FIG. 21A, three pre-prepared center angles may be selected. The reception screen 300 may include three selection buttons 301˜303 corresponding to the three center angles. A front direction may be associated with the selection button 301, and 0° may be assigned as the center angle. A minus direction may be associated with the selection button 302, and −10° may be assigned as the center angle. A plus direction may be associated with the selection button 303, and +10° may be assigned as the center angle.

Displays 301a to 303a indicating an angular direction of each center angle may be arranged on the right side of the three selection buttons 301˜303. The user can grasp the direction of the center angles assigned to the three selection buttons 301˜303 by referring to these displays 301a to 303a. The reception screen 300 may further include a confirmation button 304 for confirming the selection of the selection button 301˜303 and a button 305 for restoring the screen.

When any of the selection buttons 301˜303 is selected and the confirmation button 304 is operated, the determination in step S108 of FIG. 19 becomes YES. When the selection button 301 is selected, the frequency (e.g., 500 kHz in the example of FIG. 10) of the transmission signal corresponding to the center angle of 0° is set in step S109 of FIG. 19. When the selection button 302 is selected, the frequency (e.g., 600 kHz in the example of FIG. 11) of the transmission signal corresponding to the center angle of −10° is set in step S109 of FIG. 19. When the selection button 303 is selected, the frequency (e.g., 400 kHz in the example of FIG. 12) of the transmission signal corresponding to the center angle of +10° is set in step S109 of FIG. 19.

Note that in the configuration example of FIG. 21A, there are three selectable center angles, but the number of selectable center angles is not limited to this. The direction of each center angle is also an example, and the selectable center angle direction can be appropriately changed.

In the configuration example of FIG. 21B, the center angle (i.e., frequency of the transmission signal) can be arbitrarily set. The reception screen 300 may include an up button 311 for increasing the frequency of the transmission signal (i.e., transmission frequency) and a down button 312 for decreasing the transmission frequency. A value of a display item 313 corresponding to the transmission frequency may increase or decrease in response to an operation of the up button 311 or the down button 312, and accordingly, a value of a display item 314 corresponding to the center angle may increase or decrease. The reception screen 300 may further include a confirmation button 315 for confirming the center angle and a button 316 for restoring the screen.

The user may operate the up button 311 and the down button 312 until the value of the display item 314 reaches a desired value and then operate the confirmation button 315. As a result, the determination in step S108 of FIG. 19 becomes YES. In this case, the transmission frequency displayed in the display item 313 at the time of the confirmation operation is set in step S109 of FIG. 19.

In the configuration example of FIG. 21B, for example, a table for associating the transmission frequency displayed in the display item 313 with the center angle displayed in the display item 314 may be previously stored in the storage unit 102 of FIG. 6. In this case, even if there is not necessarily an association between the center angles and all the possible transmission frequencies, for example, a predetermined number of sets of transmission frequency/center angle may be stored in the storage unit 102, and the center angle/transmission frequency associations other than these sets may be calculated from these sets by interpolation operation. On the other hand, in the configuration example of FIG. 21A, the center angles in each direction and the transmission frequencies may be stored in the storage unit 102.

In the examples of FIG. 11 and FIG. 12, the sweep time (i.e., pulse width) was also adjusted in order to suppress noise when changing the transmission frequency. Therefore, when the transmission frequency is changed by the reception screen 300 of FIG. 21A or FIG. 21B, the sweep time may be further adjusted for noise suppression.

In addition, when the sweep direction for the plurality of transmission elements 11 included in the transmission array 10 is in the vertical downward direction, if the sign of the center angle is negative, the center angle is shifted in a vertical upward direction, and if the sign of the center angle is positive, the center angle is shifted in a vertical downward direction. Therefore, in this case, a written representation on the selection buttons 302 and 303 in FIG. 21A may be changed to upward direction and downward direction, respectively. Similarly, when the sweep direction for the plurality of transmission elements 11 included in the transmission array 10 is from the port side to the starboard side, the written representation on the selection buttons 302 and 303 in FIG. 21A may be changed to left direction and right direction, respectively.

According to the embodiments, the following effects can be achieved.

As shown in FIG. 6, a target detection device 1 includes: a transmission signal generator 103 configured to generate a transmission signal; a transmission array 10 comprising a plurality of transmission elements 11 configured to convert the transmission signal into a transmission wave, the transmission array 10 comprising at least a start transmission element 11a and an end transmission element 11b; a switch 104 configured to supply the transmission signal to the plurality of transmission elements 11 sequentially from the start transmission element 11a to the end transmission element 11b; and a controller 101 configured 20) to control a sweep time of the switch 104, which is a time from the supply of the transmission signal to the start transmission element 11a to the supply of the transmission signal to the end transmission element 11b.

According to the target detection device 1, for a device having a finite bandwidth (400˜660 kHz in this case), by changing the sweep time of the switch 104 (for example, as shown in FIGS. 7 to 9 and 13 to 15), the searchable angular range (i.e., ranges Δθa to Δθc of angle θ) corresponding to the arranged direction (i.e., sweep direction) of the transmission elements 11 can be changed. Therefore, the searchable angular range of the device having the finite bandwidth can be easily adjusted.

As shown in FIGS. 7 to 9 and 13 to 15, the sweep time (i.e., pulse width) may set an angular range (i.e., ranges Δθa to Δθc of angle θ) in which the transmission wave is transmitted. An increase of the sweep time by the controller 101 may widen the angular range.

By controlling the sweep time, the angular range in which the transmission wave is transmitted can be adjusted. Therefore, the searchable angular range for target detection can be changed by simple control.

As shown in FIGS. 6, 20A and 20B, the target detection device 1 may include a user interface 108 (e.g., reception screen 200) to be used by a user to input a value corresponding to the sweep time or the angular range.

According to this configuration, the user can set the searchable angular range to the angular range that he/she desires.

As shown in FIGS. 19, 21A and 21B, the controller 101 may further be configured to control a frequency of the transmission signal.

As shown in FIGS. 10 to 12 and 16 to 18, the frequency of the transmission signal may set a center angle (i.e., center direction) of an angular range in which the transmission wave is transmitted.

Thus, by controlling the frequency of the transmission signal, the center direction of the angular range of the transmission wave can be easily adjusted.

As shown in FIG. 6, the target detection device 1 may further include a reception array 20 including at least one reception element 21 configured to receive a reflection wave generated by reflection of the transmission wave on a target and convert the reflection wave into a reception signal; and processing circuitry (i.e., reception signal processing unit) 106 configured to extract a frequency component of the reception signal and determine a direction of arrival of the reflection wave.

According to this configuration, a target present in the angular range of the transmission wave can be detected from the reception signal outputted by the reception element 21.

As shown in FIG. 1, the target detection device 1 may be a sonar configured to detect an underwater target.

According to this configuration, a target in an underwater detection range can be detected.

As shown in FIG. 19, a target detection method executed by a controller 101 includes step S102 of performing a supply of a transmission signal to a plurality of transmission elements 11 sequentially from a start transmission element 11a to an end transmission element 11b, the plurality of transmission elements 11 converting the transmission signal into a transmission wave, and steps S106, S107 of controlling a sweep time, which is a time from the supply of the transmission signal to the start transmission element 11a to the supply of the transmission signal to the end transmission element 11b.

According to this method, as the sweep time of the transmission elements 11 is controlled, for a device having a finite bandwidth, the searchable angular range can be easily adjusted, as shown in FIGS. 7 to 9 and 13 to 15.

The present disclosure is not limited to the above embodiments. In addition, the embodiments of the present disclosure may be modified in various ways other than the above configuration.

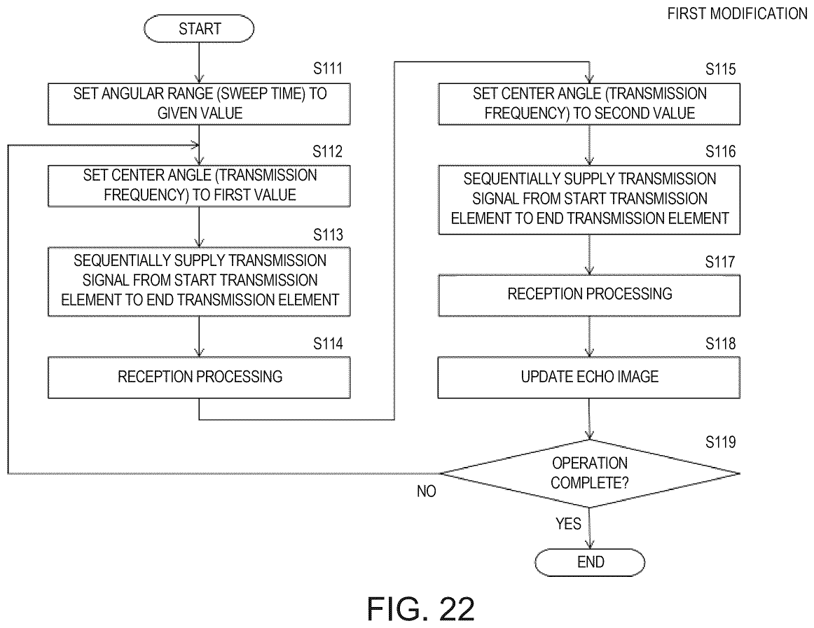

FIG. 22 is a flowchart showing the display processing of the echo image according to a first modification.

When operation of the target detection device 1 starts, the controller 101 may set the angular range (i.e., sweep time) of the transmission beam TB1 in the sweep direction to a given value at step S111 and set the center angle (i.e., transmission frequency) to a first value at step S112. Then, the controller 101 May transmit the transmission wave based on the set values. Specifically, the controller 101 may control the transmission signal generator 103 and the switch 104 so that the transmission signal is sequentially supplied to the plurality of transmission elements 11 included in the transmission array 10 from the start transmission element 11a to the end transmission element 11b at step S113.

Here, the transmission signal may be supplied simultaneously to a plurality of adjacent transmission elements 11 as shown in FIGS. 7 to 9 or may be sequentially supplied to each transmission element 11 as shown in FIGS. 13 to 15.

In accordance with the transmission of the transmission wave in step S113, the controller 101 may cause the reception processing unit 105 and the reception signal processing unit 106 to process the reception signals outputted from the plurality of reception elements 21 included in the reception array 20 and acquire intensity data (i.e., volume data) distributed in a first detection range at step S114.

Next, the controller 101 may set the center angle (i.e., transmission frequency) to a second value at step S115 and transmit the transmission wave based on the set second value. Specifically, the controller 101 may control the transmission signal generator 103 and the switch 104 so that the transmission signal is sequentially supplied to the plurality of transmission elements 11 included in the transmission array 10 from the start transmission element 11a to the end transmission element 11b at step S116. At this time, the sweep time may be maintained at the value set in step S111.

In accordance with the transmission of the transmission wave in step S116, the controller 101 may cause the reception processing unit 105 and the reception signal processing unit 106 to process the reception signals outputted from the plurality of reception elements 21 included in the reception array 20 and acquire intensity data (i.e., volume data) distributed in a second detection range at step S117. At step S118, the controller 101 may update the echo image displayed on the display unit 107 with the intensity data (i.e., volume data) acquired in steps S114 and S117.

After updating the echo image, the controller 101 may determine whether the operation of the target detection device 1 is completed at step S119. When the operation of the target detection device I is not completed (step S119: NO), the controller 101 may return the processing to step S112 and execute the processing of the next sequence. The controller 101 may repeatedly execute the processing of steps S112 to S118 until the operation of the target detection device 1 is completed (step S119: NO). Thereafter, when the operation of the target detection device 1 is completed (step S119: YES), the controller 101 may terminate the processing of FIG. 22.

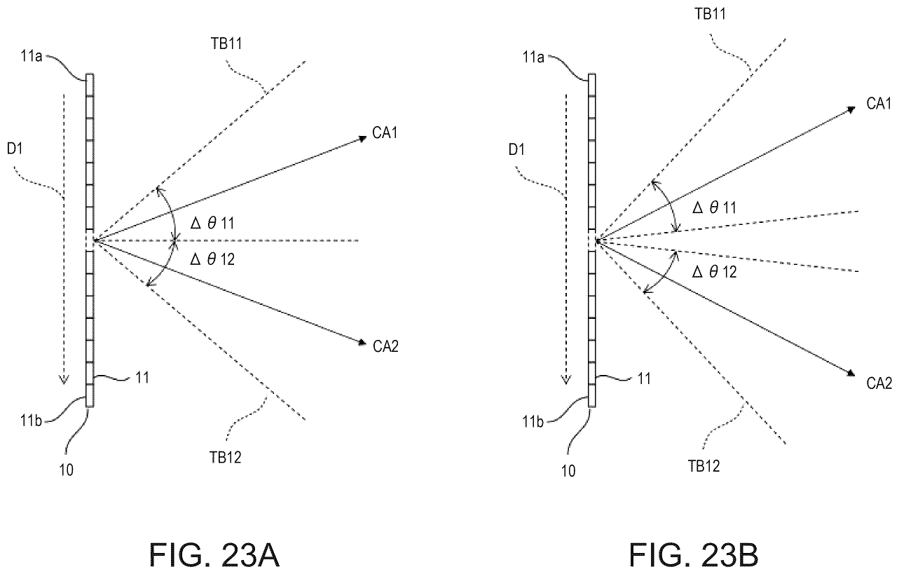

FIG. 23A and FIG. 23B are diagrams schematically showing setting examples of the center angle in steps S112 and S115 of FIG. 22.

In FIG. 23A and FIG. 23B, a state of the transmission wave when the transmission array 10 is viewed from the side is indicated by a dashed line. More specifically, a direction of the center angle set in step S112 is indicated as a first center angle direction CA1, and a direction of the center angle set in step S115 is indicated as a second center angle direction CA2. Further, the transmission beam formed by the processing in step S113 in FIG. 22 and its angular range (i.e., angular range of the moving direction D1) are indicated as a first transmission beam TB11 and a first angular range Δθ11, and the transmission beam formed by the processing in step S116 in FIG. 22 and its angular range (i.e., angular range of the moving direction D1) are indicated as a second transmission beam TB12 and a second angular range Δθ12.

In the setting example in FIG. 23A, the first center angle direction CA1 and the second center angle direction CA2 are set so that a lower boundary of the first angular range Δθ11 coincides with an upper boundary of the second angular range Δθ12. That is, the sweep time in step S111 in FIG. 22 and the transmission frequencies in steps S112 and S115 are set so that the first angular range Δθ11 and the second angular range Δθ12 have such a relationship. In this setting example, a wide angular range combining the first angular range Δθ11 and the second angular range Δθ12 can be set to the searchable angular range.

In the setting example of FIG. 23B, the first center angle direction CA1 and the second center angle direction CA2 are set so that the lower boundary of the first angular range Δθ11 and the upper boundary of the second angular range Δθ12 are separated. That is, the sweep time in step S111 of FIG. 22 and the transmission frequencies in steps S112 and S115 are set so that the first angular range Δθ11 and the second angular range Δθ12 have such a relationship. In this setting example, the first angular range Δθ11 and the second angular range Δθ12 can be set to the searchable angular range, respectively.

As shown in FIGS. 22, 23A, and 23B, at a first timing (i.e., steps S112 to S114), the controller 101 may be configured to set the frequency of the transmission signal to a first frequency at step S112 to transmit the transmission wave with the center direction in a first direction (i.e., first center angle direction CA1), and, at a second timing (i.e., steps S115 to S117) after the first timing, the controller 101 may be configured to set the frequency of the transmission signal to a second frequency different from the first frequency at step S115 to transmit the transmission wave with the center direction in a second direction (i.e., second center angle direction CA2) different from the first direction.

As shown in FIG. 23A and FIG. 23B, since the center directions (i.e., first center angle direction CA1, second center angle direction CA2) of the angular ranges of the transmission waves are different between the first timing and the second timing, the searchable angular range can be set to a wide angular range corresponding to an entire angular range of these ranges.

In the process shown in FIG. 22, two sets of the center angle direction & the angular range were set, but three or more sets of the center angle direction & the angular range may be set. The setting method of each set is not limited to the methods shown in FIG. 23A and FIG. 23B, and a part of the first angular range ΔΘ11 and a part of the second angular range Δθ12 may be overlapped. In this case, the volume data of the overlapped range may be configured as an echo image using only the volume data of one of the angular ranges.

In the configuration of the first modification, the user may set the first angular range Δθ11 and the second angular range Δθ12 (i.e., respective sweep times), and the user may set the first center angle direction CA1 and the second center angle direction CA2 (i.e., respective transmission frequencies). Thus, the user's convenience can be enhanced.

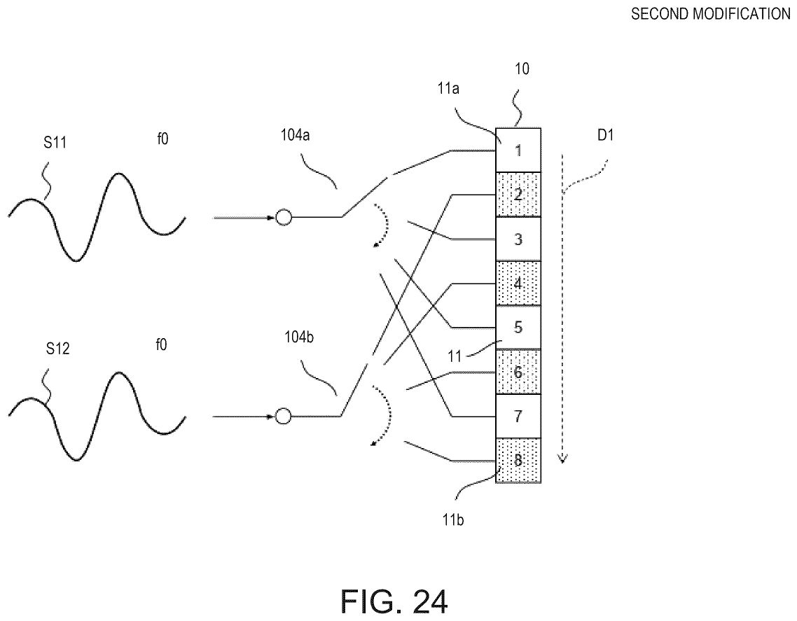

FIG. 24 is a diagram showing a method of supplying the transmission signal to the transmission elements 11 according a second modification.

In the second modification, transmission signals S11 and S12 may be supplied separately to odd-numbered transmission elements 11 and even-numbered transmission elements 11 among the plurality of transmission elements 11 included in the transmission array 10. Carrier frequencies of the transmission signals S11 and S12 may be all constant at the frequency f₀. The odd-numbered transmission elements 11 to which the transmission signal S11 is supplied may be sequentially switched in the moving direction D1 by a switch 104a. The even-numbered transmission elements 11 to which the transmission signal S12 is supplied may be sequentially switched in the moving direction D1 by a switch 104b.

A time the transmission signal S11 is supplied to an odd-numbered transmission element 11 and a time the transmission signal S12 is supplied to an even-numbered transmission element 11 may have the same length. However, the time the transmission signal S12 is supplied to the even-numbered transmission element 11 may be delayed by half of the time the transmission signal S11 is supplied to the odd-numbered transmission element 11. That is, a timing when the transmission signal S12 is supplied to the even-numbered transmission element 11 relative to a timing when the transmission signal S11 is supplied to the odd-numbered transmission element 11 may be delayed by half of the time the transmission signals S11 and S12 are supplied to the transmission elements 11.

In the second modification, the transmission signals S11 and S12 are supplied to the transmission elements 11 in order from the start transmission element 11a to the end transmission element 11b under control of the switches 104a and 104b as described above.

In this configuration, since the transmission signal S12 is being supplied to the even-numbered transmission element 11 at the switching timing of the odd-numbered transmission element 11, unnecessary frequency components (i.e., spurious) due to the switching of the odd-numbered transmission element 11 are suppressed. Similarly, since the transmission signal S11 is being supplied to the odd-numbered transmission element 11 at the switching timing of the even-numbered transmission element 11, unnecessary frequency components (i.e., spurious) due to the switching of the even-numbered transmission element 11 are suppressed. In the configuration of FIG. 24, amplitudes of the transmission signals S11 and S12 may be modulated so as to effectively suppress occurrence of such unnecessary frequency components (i.e., spurious).

In the configuration of the second modification, as in the above embodiments, the angular range of the transmission beam TB1 in the moving direction D1 (i.e., sweeping direction) can be changed by changing the sweep time, which is the time for supplying the transmission signals S11 and S12 from the start transmission element 11a to the end transmission element 11b. In the configuration of the second modification, as in the above embodiments, the direction of the center angle of the angular range can be changed by changing the frequencies of the transmission signals S11 and S12. In the configuration of the second modification, the configuration of the first modification may be applied.

Although eight transmission elements 11 are shown in FIG. 24, the number of transmission elements 11 included in the transmission array 10 is not limited thereto. It can be assumed that the actual number of transmission elements 11 is larger than eight.

In the above embodiments, the transmission beam TB1 is formed by a single sweep that sequentially supplies the transmission signal to the transmission elements 11 from the start transmission element 11a to the end transmission element 11b, but the transmission beam TB1 may be formed by consecutively repeating that sweep a plurality of times. Even with such control, the transmission beam TB1 can have change in frequency in the sweep direction, and the angular range of the transmission beam TB1 can be changed by changing the sweep time (i.e., moving speed of the transmission source).

According to this control, a frame rate of the echo image decreases by repeated sweeps but a power of the transmission beam TB1 can be increased. Therefore, a distance up to which target detection is possible can be extended. With such control, in order to enhance the distance resolution, a carrier frequency of the transmission signal may be frequency modulated like a chirp signal, and a matched filter may be arranged in the reception signal processing unit 106.

In the simulation of FIGS. 7 to 12, a supply destination of the transmission signal is sequentially switched for three successive transmission elements 11, but the supply destination of the transmission signal may be sequentially switched for a plurality of successive transmission elements 11 other than three.

In the above embodiments, it has been explained that the frequency component of each frequency is extracted from the reception signal and then there is separation into a signal for each azimuth by the beamforming process. However, the reception signal may first be separated into a signal of each azimuth by the beamforming process, and the frequency component of each frequency may be extracted from the signal of each azimuth after the separation.

In the above embodiments, as shown in FIG. 2A and FIG. 2B, plurality of reception elements 21 is provided, but reception of the reflection wave may be performed with only a single reception element 21. However, in this case, since the intensity data of the reception signal cannot be separated in each azimuth and mapped on the equal-frequency surfaces, the state of the detection range cannot be displayed in a three-dimensional image as in the above embodiments. In this configuration, the azimuth of the reception beam (i.e., azimuth θ2 in FIG. 5) is fixed. By extracting the frequency component of the reception signal from the reception beam of that azimuth, the intensity data of each direction in the vertical direction can be acquired. Therefore, by mapping the intensity data of each direction in the vertical direction, a two-dimensional detection image can be displayed.

In addition, although the transmission signals S11 and S12 are the same signals in the second modification, the transmission signals S11 and S12 may be different from each other as long as the unnecessary frequency components of the transmission wave can be suppressed. In addition, the carrier frequencies of the transmission signals S11 and S12 may not necessarily be constant, and the carrier signals may be frequency-modulated like chirp signals. The transmission signals S11 and S12 may also be burst signals.

Further, the switching timing of the odd-numbered transmission element 11 serving as the supply destination of the transmission signal S11 and the switching timing of the even-numbered transmission element 11 serving as the supply destination of the transmission signal S12 are not limited to the aforementioned timing and may be other timings as long as unnecessary frequency components generated in the transmission wave can be suppressed. Further, the configuration of the transmission array 10 is not limited to the configurations of the above embodiments and may be other configuration as long as a change in frequency based on the Doppler effect can be generated in the transmission beam TB1.

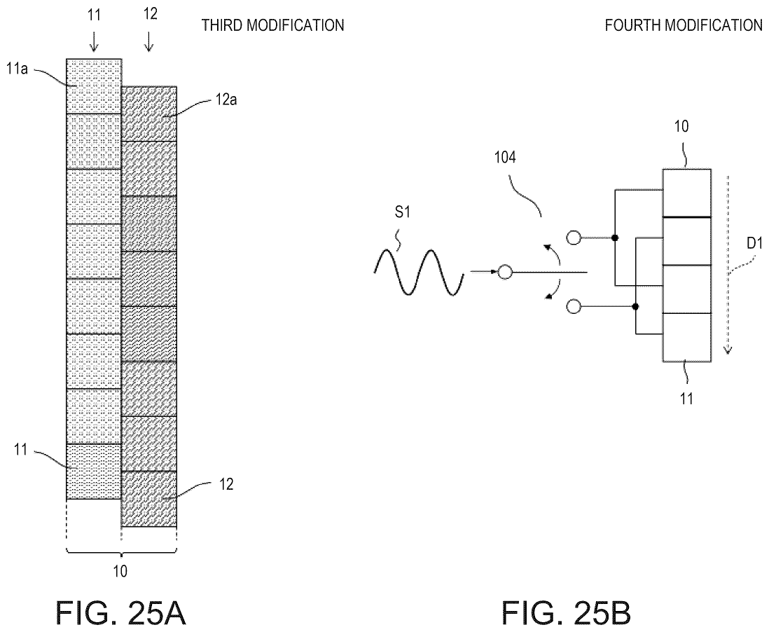

For example, as in a third modification shown in FIG. 25A, two rows of transmission elements 11 and 12 may be arranged so that a transmission element 12 is positioned on a side of a boundary between two adjacent transmission elements 11. In this case, the transmission signal S11 and the transmission signal S12 may also be supplied to the respective transmission elements 11 and 12 in order from start transmission elements 11a and 12a at the same timing as in FIG. 24. Thus, as in the above second modification, unnecessary frequency components generated in the transmission wave can be suppressed.

Further, as in a fourth modification shown in FIG. 25B, the plurality of transmission elements 11 may be grouped into a plurality of groups, and the supply destination of the transmission signal S1 may be switched between the groups by the switch 104. This configuration also allows the transmission source to move in the moving direction D1, so that a change in frequency based on the Doppler effect can occur in the transmission beam TB1. In addition, since the transmission wave is transmitted by each group, power of the transmission wave can be increased. The number of transmission elements 11 to be grouped is not limited to two but may be three or more.

The number of transmission elements 11 is not limited to the number shown in the above embodiments and may be any other number as long as it is a plurality. In the above embodiments, the transmission array 10 and the reception array 20 are arranged perpendicularly to each other, but the transmission array 10 and the reception array 20 may be arranged at an angle slightly deviating from 90 deg.

Furthermore, in the above embodiments, the target detection device 1 is a sonar installed on the ship 2, but the target detection device 1 may be a radar for detecting targets in air. In this case, for example, a transducer may be installed on a side wall of the wheelhouse 2a. The transducer may include a transmission array 10 and a reception array 20. The transmission array 10 may transmit a transmission wave into the air by the process described above. Here, a radio wave may be transmitted as the transmission wave. Circuitry may be installed in the wheelhouse 2a as in the case of the sonar.

According to this configuration, a detection image showing an obstacle, or a flock of birds may be displayed on the display unit 107. Thus, the user can grasp the situation in the air. The transducer may be installed on each of the front, rear, left and right sides of the wheelhouse 2a. In this case, for each transducer, the configuration of the transmitter and receiver systems illustrated in FIG. 6 are arranged. As a result, the detection image of the space all around the ship can be displayed on the display unit 107.

The target detection device 1 may be installed on a mobile structure other than the ship 2, or the target detection device 1 may be installed on a structure other than a mobile structure such as a buoy.

In addition, the embodiments of the present disclosure may be suitably modified within the scope of the appended claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A target detection device, comprising:
a transmission signal generator configured to generate a transmission signal;
a transmission array comprising a plurality of transmission elements configured to convert the transmission signal into a transmission wave, the transmission array comprising at least a start transmission element and an end transmission element;
a switch configured to supply the transmission signal to the plurality of transmission elements sequentially from the start transmission element to the end transmission element; and
a controller configured to control a sweep time of the switch, the sweep time being a time from the supply of the transmission signal to the start transmission element to the supply of the transmission signal to the end transmission element.

2. The target detection device of claim 1, wherein the sweep time sets an angular range in which the transmission wave is transmitted.

3. The target detection device of claim 2, wherein an increase of the sweep time by the controller widens the angular range.

4. The target detection device of claim 2, further comprising a user interface to be used by a user to input a value corresponding to the sweep time or the angular range.

5. The target detection device of claim 1, wherein the controller is further configured to control a frequency of the transmission signal.

6. The target detection device of claim 5, wherein the frequency of the transmission signal sets a center direction of an angular range in which the transmission wave is transmitted.

7. The target detection device of claim 6, wherein
at a first timing, the controller is configured to set the frequency of the transmission signal to a first frequency to transmit the transmission wave with the center direction in a first direction; and
at a second timing after the first timing, the controller is configured to set the frequency of the transmission signal to a second frequency different from the first frequency to transmit the transmission wave with the center direction in a second direction different from the first direction.

8. The target detection device of claim 1, further comprising:
a reception array comprising at least one reception element configured to receive a reflection wave generated by reflection of the transmission wave on a target and convert the reflection wave into a reception signal; and
processing circuitry configured to extract a frequency component of the reception signal and determine a direction of arrival of the reflection wave.

9. The target detection device of claim 1, wherein the target detection device is a sonar configured to detect an underwater target.

10. A target detection method, comprising:
performing a supply of a transmission signal to a plurality of transmission elements sequentially from a start transmission element to an end transmission element, the plurality of transmission elements converting the transmission signal into a transmission wave; and
controlling a sweep time, the sweep time being a time from the supply of the transmission signal to the start transmission element to the supply of the transmission signal to the end transmission element.

11. A non-transitory computer-readable medium having stored thereon computer-executable instructions which, when executed by a controller of a target detection device, cause the controller to:
perform a supply of a transmission signal to a plurality of transmission elements sequentially from a start transmission element to an end transmission element, the plurality of transmission elements converting the transmission signal into a transmission wave; and
control a sweep time, the sweep time being a time from the supply of the transmission signal to the start transmission element to the supply of the transmission signal to the end transmission element.
